(19) United States
(12) Patent Application Publication
(10) Pub. No.: US 2003/0098930 A1
(43) Pub. Date: May 29, 2003

(54) Digital dynamic convergence control system in a display system

(75) Inventors: Seung Won Seo, Chungju-Shi (KR); Hyo Seok Kwon, Ansan-Shi (KR); Young Hoon Jung, Seoul (KR); Ick Chan Shim, Suwon-Shi (KR)

Correspondence Address: DARBY & DARBY P.C., 805 Third Avenue, New York, NY, 10022, US

(73) Assignee: SAMSUNG ELECTRO-MECHANICS CO., LTD.

(21) Appl. No.: 10/052,799

(22) Filed: Jan. 18, 2002

(30) Foreign Application Priority Data
Nov. 23, 2001 (KR) 2001-73180

(51) Int. Cl. H04N 17/00; H04N 3/22

(52) U.S. Cl. 348/806; 348/189

(57) ABSTRACT

The digital dynamic convergence error control system for controlling convergence errors is provided. The system includes a convergence error detecting apparatus recognizing crossing points of a screen pattern displayed on a screen of a display device and detecting each amount of convergence errors corresponding to respective crossing points, a main control means generating correction data in response to respective convergence errors and generating interpolation data using the correction data of adjacent crossing points, and a digital dynamic convergence error control apparatus receiving the correction data and the interpolation data from the main control means, storing the correction data and the interpolation data in a memory, converting each of the correction data and the interpolation data into voltage or current in response to respective horizontal synchronization signals extracted from a picture signal, and independently and separately applying the voltage or the current to a magnetic field controlling coil only during a corresponding period of respective horizontal synchronization signals.

### BACK GROUND OF THE INVENTION

1. Field of the Invention

The present invention relates to a digital dynamic convergence error control system adapted for use in a deflection yoke of a display device, and more particularly, to a digital dynamic convergence error control system performing separate and independent convergence error corrections corresponding to both respective crossing points of a reference screen pattern and respective areas between the crossing points of the reference screen pattern.

2. Description of the Related Art

Generally, a deflection yoke performs a function of deflecting R, G, B electron beams landed on a desired position of a screen in a CRT display apparatus. Although the picture quality of the screen is required to a high definition or resolution, a conventional deflection yoke cannot achieve an improved convergence function for obtaining the high definition of the picture quality. Therefore, various types of auxiliary correction devices have been mounted in the deflection yoke for the convergence function for the high definition and resolution of the picture screen.

The yoke has been provided with a dynamic convergence controller mounted on a neck portion of the yoke having a plurality of magnetic controlling coils for generating one of two pole magnetic fields, four pole magnetic fields, and six pole magnetic fields using convergence purity magnet operation principles so that a G electron beam is moved to a desired position relative to R and B electron beams.

The dynamic convergence controller is necessary to obtain the high resolution of the same picture quality as a HDTV for processing a character and transferring character information in the presence of the digital TV broadcast.

Typically, the dynamic convergence controller of the conventional deflection yoke is provided with a plurality of resistors, inductors, capacitors, and diodes. The convergence error is compensated by controlling the current of the magnetic field controlling coils using an adjustment means such as a variable resistor of the dynamic convergence controller circuit.

With the conventional convergence controller, only a predetermined current wave is input to the magnetic controlling coils so that only a convergence error having a predetermined pattern is controlled. When a convergence error for a predetermined area of the screen is corrected, another error for the other area of the screen is incurred because the other convergence error of the other area varies in response to the convergence error for the predetermined area. Therefore, it is disadvantageous that all of the errors throughout the entire screen may not be controlled

When the convergence error manually detected in a manufacturing process of the deflection yoke and the CRT display apparatus is controlled in accordance with the manual detection, it is impossible to control the convergence error of the entire screen of a flat and wide angle CRT display apparatus.

In an effort of overcoming the problems incurred in the manual adjustment of the convergence error with the user's manual detection, a detecting apparatus adapted for use in a liquid crystal display or a plasma display panel had been proposed for detecting and displaying convergence errors.

This detecting apparatus includes a predetermined screen pattern having each color disposed on the screen of the detected CRT display apparatus, an image detecting device for detecting the screen pattern in each color components of R, G, and B (RGB), an image processor processing the detected RGB components, and a display displaying the results of the processing of the image processor.

For example, Japanese patent publication 8-307898 published in 1996 discloses a convergence detecting apparatus detecting a predetermined white screen pattern displayed on a CRT using a camera having color detecting sensors, such as a charge coupled device, calculating respective luminance centers of RGB components of the screen pattern displayed on the CRT detected with respect to the white screen pattern and controlling the screen pattern with te relative displacements of the luminance centers being regarded as convergence errors. Therefore, this convergence detecting apparatus calculates the light emitting position of each color components on the screen pattern using the luminance position in the screen pattern of each color components, and calculates the relative displacements of the light emitting positions of the respective color components.

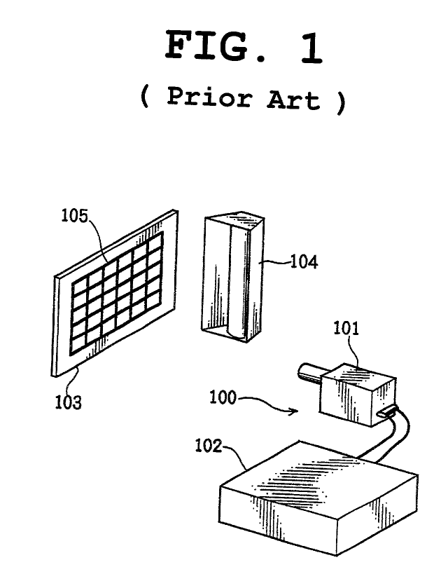

This detecting apparatus shows disadvantages in that the detected errors vary in response to humidity and temperature. Therefore, adjustment chart illuminated by a lamp 104 shown in FIG. 1 is needed before the convergence error is detected.

The adjustment chart is a cross line pattern 105 formed on an opaque white plate. The adjustment chart disposed on the screen is detected on the image detecting device 101 of convergence detecting apparatus 100, and adjustment data for the relative position of each area color using the detected image. The calculated adjustment data is stored in a memory and used for controlling the screen pattern in each color components.

In the conventional method of correcting the relative deviation of the areas sensors, each position of area sensors in the reference coordinate system of the convergence detecting apparatus is calculated using image data of each color components obtained from the detected adjustment chart. Therefore, it takes a longer period of time to compute the adjustment data as the parameters for the calculation increase. Moreover, it is impossible to control and adjust the convergence detecting system in the manufacturing process because the specific additional adjustment chart is used instead of a screen pattern displaced on the CRT.

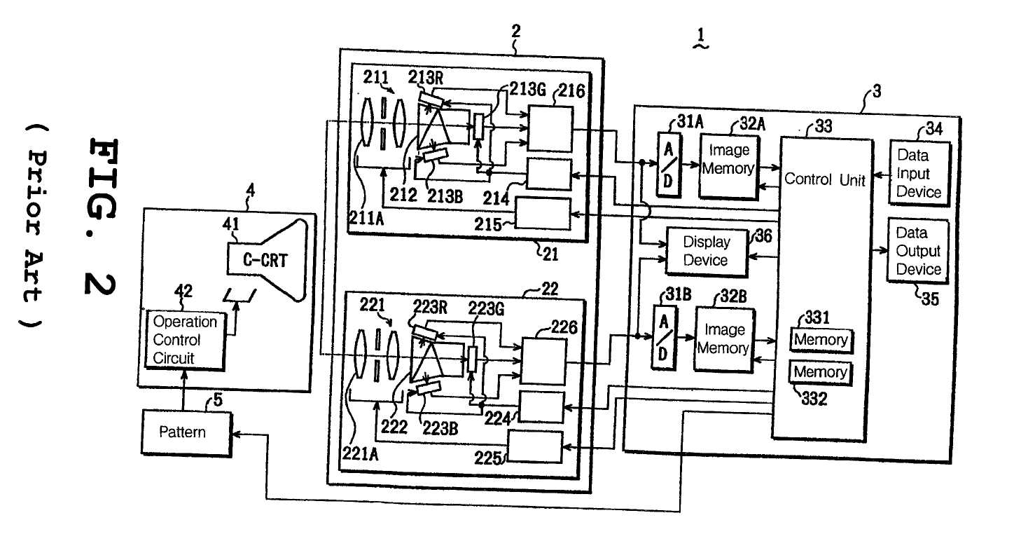

In another effort of improving the above disadvantages, Korean patent publication 1999-013780 discloses automatic convergence detecting apparatus in a color CRT as shown in FIG. 2. FIG. 1 is a schematic diagram of the convergence detecting apparatus 1 including an image detecting device 2 and an error detecting device 3.

The image detecting device 2 detects a predetermined detecting pattern, as such a screen pattern having a horizontal and vertical cross lines or a dotted pattern, displayed on a display 4 detected and includes a pair of cameras 21, 22 for detecting a pair of stereo images from the detecting pattern. The error detecting device 3 calculates the amount of the convergence error using the stereo image data and displays the calculated convergence error on display device 36.

Camera 21, 22 includes dichroic prism 212 disposed adjacent to an image lens unit 211 to disperse a beam of light into three color components, image detecting elements 213R, 213 G, 213B including the charge coupled device (CCD) in a position corresponding to each of three color components emitted from the prism 212.

Camera 21, 22 includes an image detecting circuit 214 controlling the image detecting elements (CCD) 213R, 213G, 213B, a focusing element 215 automatically controlling a focus of the image lens, and a signal processor 216 processing image signals transmitted from CCD 213R, 213G, 213B and generating the image signals to image detecting device 3.

The image detecting circuit 214, 224 is controlled by an image detecting control signal generated from image detecting device 3, and the detecting operation relating to electron charging operation of CCD 213R, 213G, 213B is controlled by the image detecting control signals.

Focus controlling circuit 215, 225 is controlled by a focusing control signal transmitted from image detecting device 3. Therefore, a group of lens 211A of image lens unit 211 is operated, and an optical image of the screen pattern displayed on the CRT is converged onto an image detecting surface of CCD 213R, 213G, 213B.

A focus control operation is performed by a focusing signal from controller 33. In camera 21, controller 33 extracts high frequency component of the green image (edge of the screen pattern) from the image detected by CCD 213G and outputs the focusing signal to focus control circuit 215 so that the high frequency component is maximized to make the edge of the screen pattern clear.

Focus control circuit 215 move the group of lens 211A in forward and backward directions in order to adjust the focus of the image lens unit 211.

Although the focus control operation is performed using the detected image as explained above, the focus control operation, however, is performed using a distance between the camera and a display surface of the color CRT, since camera 21, 22 is provided with a sensor for detecting the distance.

Image detecting device 3 includes analog/digital (A/D) converter 31A, 31B, image memories 32A, 32B, a controller 33m a data input device 34, a data output device 35, and a display device 36.

A/D converter 31A, 31B converts an analog image signal into a digital input image signal. Image memories 32A, 32b stores the digital input image signal generated from A/D converter 31A, 31B.

Each of A/D converter 31A, 31B is provided with three A/D converter circuits corresponding to respective RGB components of the image signals. Each of image memories 32A, 32B includes three frame memories corresponding to respective RGB components of the image signals.

Controller 33 includes a microcomputer, a ROM 331, and a RAM 32. ROM 331 stores a program for processing a convergence error detecting process including an optical system driving process, image data computing process, etc., and stores data, such as the convergence error correcting data and the data converting table. RAM 332 is divided into a plurality of data areas and process areas for performing each step of the convergence error detecting process.

The amount of the convergence error computed in controller 33 is stored in RAM 332, displayed on display device 36 in a predetermined format, and also printed in an external apparatus, such as printer or external storage, through data output device 35.

Data input device 34 includes a keyboard for inputting carious data for the convergence error detecting process, and inputs data for pitches between pixels of CCD 213, 223 and for detecting the points of the display surface of color CRT display device 4.

Color CRT display device 4 to be detected includes a color CRT displaying an image, and a driving control circuit 42 controlling operations of the color CRT.

A pattern generator 5 generates a video signal for the screen pattern. The video signal for the screen pattern is input to driving color circuit 42. The deflection circuit of color CRT 41 is driven by the video signal, and the screen pattern having horizontal and vertical cross lines is displayed on the color CRT 4.

In convergence error detecting apparatus 1, the screen pattern is detected by a pair of camera 21, 22 of image detecting device 2, and the amount of the convergence error is calculated using the image data obtained from camera 21, 22.

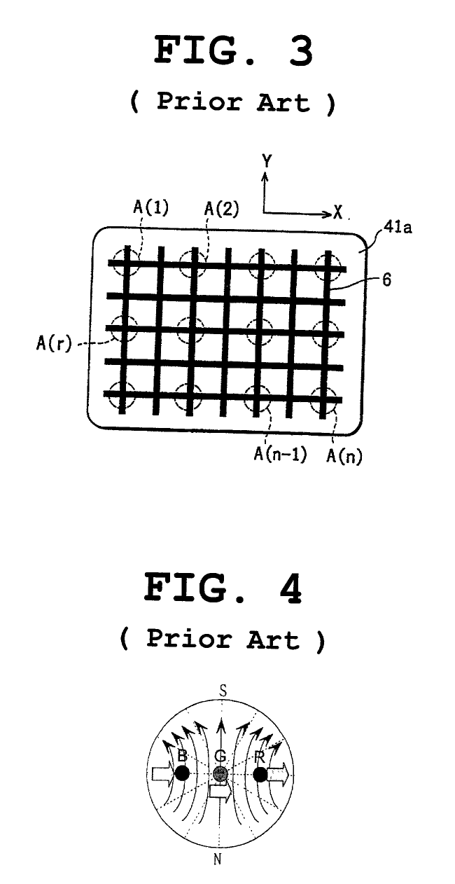

FIG. 3 is a diagram showing a screen pattern 6 displayed on the color CRT 41. Screen pattern 6 includes a plurality of vertical lines and horizontal lines perpendicular to the vertical lines. Screen pattern 6 having a plurality of crossing points formed by the vertical lines and the horizontal lines is displayed on the display surface 41a of color CRT. One of detecting area A1 through An for detecting the amount of the convergence error includes at least one cross point.

In each detecting area Ar (r=1, 2, . . . n), the amount of horizontal convergence error DX in a direction X in an XY coordinate is obtained from the image detection of vertical lines included in the detecting area Ar, and the amount of vertical convergence error DY in a direction Y in the XY coordinate is obtained from the image of horizontal lines included in the detecting area Ar.

Each if the exact amount of the convergence error is obtained, it is impossible to independently control each area with independent convergence error corresponding to the respective independent area because the convergence error obtained from the screen pattern effects the entire area. Therefore, one area is corrected with the convergence error while the other area is not corrected with the convergence error.

If one portion of the convergence error is controlled, then the other portion of convergence varies because the convergence error controls the entire portions. However, it is impossible to correct the respective convergence error in a HDTV having a high resolution.

### SUMMARY OF THE INVENTION

It is an object of the present invention to provide an improved dynamic convergence control system able to control magnetic fields of a deflection yoke with separate and independent convergence error correction data corresponding to respective pixels in a screen.

It is another object to provide an improved dynamic convergence control system capable of performing separate and independent convergence correcting operations corresponding to each point of a horizontal and vertical reference pattern of a screen.

It is still another object to provide an improved dynamic convergence control system capable of performing separate and independent convergence error correcting operations corresponding to each area between crossing points of a horizontal and vertical reference pattern of a screen.

It is yet another object to provide a dynamic convergence control system able to adjust first separate and independent convergence error correction data corresponding to respective pixels in a first screen having a first screen size to second separate and independent convergence error correction data corresponding to respective pixels in a second screen having a second screen size.

It is still yet another object to provide a dynamic convergence control system able to generate at least two separate and independent convergence error correction data for each field of a picture frame.

It is also an object to provide a dynamic convergence control system able to generate at least two separate and independent convergence error correction data corresponding to magnetic field controlling coils in each field of a picture frame.

It is further an object to provide a dynamic convergence control system provided with eight convergence control coils able to selectively generate two pole magnetic fields, four magnetic fields, and six magnetic fields.

It is further an object to provide a dynamic convergence control system able to operate eight convergence control coils as two convergence correcting coils for generating two magnetic fields having a horizontal axis or a vertical axis, four convergence correcting coils for generating four pole magnetic fields having a horizontal axis or a vertical axis, and six convergence correcting coils for generating six pole magnetic fields.

It is further an object to provide a dynamic convergence control system able to generate a plurality of variable convergence correction signals for a field of a picture frame.

It is further an object to provide a dynamic convergence control system able to generate a plurality of variable convergence correction signals for each of R, G, B deflection yokes of a display device.

It is further an object to provide a dynamic convergence error correcting system able to prevent each independent convergence error correction data corresponding to respecting correction points of a screen from affecting other correction points when a specific point of the screen is corrected by the convergence error correction data corresponding to the specific point.

It is a further object to provide a dynamic convergence error correcting system able to store a plurality of convergence error correction data corresponding to crossing points of a screen and a plurality of interpolation data corresponding to an area disposed between adjacent crossing points of the screen.

It is a further object to provide a display device having a dynamic convergence error correcting apparatus able to generate a plurality of independent convergence error correction data corresponding respective correction points disposed within a period of a horizontal synchronization signal.

It is a further object to provide a deflection yoke having a dynamic convergence error correcting apparatus able to generate a plurality of independent convergence error correction data corresponding respective correction points disposed within a period of a horizontal synchronization signal.

These and other objects may be achieved by providing a digital dynamic convergence error control system for performing separate and independent convergence error correcting operations corresponding to each crossing point of a horizontal and vertical reference pattern of a screen by receiving separate and independent correction data corresponding to respective crossing points of the screen from an external device, storing the correction data in a memory, reading the correction data from the memory in response to a picture scanning period other than a blanking period using horizontal and vertical synchronization signals, adjusting voltage or current of magnetic field control coils in accordance with the convergence error correction data. The system performs separate and independent convergence operations corresponding to each area between the points of a horizontal and vertical reference pattern of a screen by generating separate and independent interpolation data corresponding to each area between the correction points of the horizontal and vertical reference pattern of the screen and adjusting voltage or current of the magnetic coils in accordance with the interpolation data.

The system includes a method of storing a plurality of convergence error correction data corresponding to crossing points of a screen, storing a plurality of interpolation data corresponding to an area disposed between adjacent crossing points of the screen, applying the convergence correction data to respective convergence coils when the corresponding crossing point is scanned, and applying the interpolation data when the corresponding area is scanned.

The system includes a method of generating a plurality of convergence error correction data being independent from each other and independently applying each of the convergence error correction data to convergence coils when each horizontal synchronization signal corresponding to each convergence error correction data starts.

The digital dynamic convergence error control system includes a convergence error detecting apparatus recognizing crossing points of a screen pattern displayed on a screen of a display device and detecting each amount of the convergence error corresponding to respective crossing points, a main control means generating correction data in response to respective convergence errors and generating interpolation data using the correction data of adjacent crossing points, and a digital dynamic convergence error control apparatus receiving the correction data and the interpolation data from the main control means, storing the correction data and the interpolation data in a memory, converting each of the correction data and the interpolation data into voltage or current in response to respective horizontal synchronization signals extracted from a picture signal, and independently and separately applying the voltage or the current to a magnetic field controlling coil only during a corresponding period of respective horizontal synchronization signals.

The digital dynamic convergence error control apparatus of the system is integrated in a single chip having a monolithic structure.

The crossing points of the screen pattern corresponding to respective correction data and being formed by horizontal lines and vertical lines.

The interpolation data is generated in an area disposed between the adjacent crossing points of the screen pattern, the area corresponding to horizontal synchronization signals of the picture signal disposed between the adjacent crossing points of the screen pattern, the crossing points of the screen pattern being formed by horizontal lines and vertical lines.

The digital dynamic convergence error control apparatus of the system includes a controller receiving the correction data, the interpolation data, and control command signals from the main control means, generating addresses corresponding to each of the correction data and the interpolation data, storing the correction data and the interpolation data in respective addresses of the memory, controlling an address bus and a data bus to read the correction data and the interpolation data from respective addresses of the memory. The digital dynamic convergence error control apparatus includes a reference clock generator generating clock signals in response to a clock control signal inputted from the controller, an address generator generating an interrupt signal and setup signals for calculating the interpolation data corresponding to an area between adjacent crossing points in response to horizontal and vertical synchronization signals extracted from the picture signal, control signals generated from the controller, and the clock signals generated from the reference clock generator, an internal memory storing the correction data and the interpolation data inputted into the controller, and an output section converting the correction data and the interpolation data into the voltage and the current in response to output control signals generated from the controller and a conversion control signal generated from the address generator, and applying the voltage and the current to the magnetic field controlling coils for generating more than two pole magnetic fields.

The control signals of the controller include a skip number, a first dividing ratio, a pass number, and a second dividing ratio, a first comparator clock number, and a main clock signal transmitted to the reference clock generator.

The setup signals of the address generator include an NCNT signal, a horizontal address, a vertical address, a horizontal control signal, and a vertical control signal.

The system includes a nonvolatile external memory disposed outside the digital dynamic convergence error correcting apparatus, coupled to the controller, storing the correction data and the interpolation data, the correction data and the interpolation data stored in the nonvolatile memory transmitted to the internal memory in response to a request signal of the controller.

The controller of the digital dynamic convergence error control apparatus in the system generates the control signals by counting the number of the clock signals generated from the reference clock generator during a period of a horizontal synchronization signal of the picture signal in response to the clock control signal of the controller. The address generator of the digital dynamic convergence error control apparatus includes a first counter and a first comparator generating an NCNT signal as one of setup signals in response to the number of the clock signals which are counted during the period of the horizontal synchronization signal and generating a first interrupt signal whenever there exists a difference between the NCNT and a reference, a first divider receiving a skip number and a first dividing ratio and generating a horizontal control signal as one of the setup signals after dividing by the first dividing ratio a remaining portion of the horizontal synchronization signal remained after skipping the horizontal synchronization signal by a number of clock signals corresponding to the skip number, a second counter for generating a horizontal address signal by counting the horizontal control signal generated from the first divider, a second divider receiving a pass number and a second dividing ratio and generating a vertical control signal after dividing by the second dividing ratio a remaining portion of the vertical synchronization signal remained after passing a number of horizontal synchronization signals corresponding to the pass number during a period of the vertical synchronization signal, a third counter generating a vertical address signal by counting the vertical control signal generated from the second divider, a fourth counter generating a count value by counting the number of clocks corresponding to the horizontal synchronization signals during the period of the vertical synchronization signal, and a second comparator receiving the count value generated from fourth counter, outputting a second interrupt signal whenever a difference between the count value and a second reference by counting the number of clocks in every vertical synchronization signal only when the first comparator generates the first interrupt signal.

The output section of the digital dynamic convergence error control apparatus in the system includes a plurality of digital to analog converters converting into each analog signal the correction data and the interpolation data corresponding to respective magnetic field correcting coils generating more than two pole magnetic fields corresponding to respective vertical and horizontal axes of the magnetic field correcting coils. The output section includes a plurality of correction and interpolation sections coupled to respective digital to analog converters, receiving the correction data and the interpolation data from the internal memory, transmitting the correction data and the interpolation data to corresponding the digital to analog converter so as to control respective magnetic field controlling coils designated by each coil address generated from the address generator with corresponding correction data and the interpolation data.

The digital dynamic convergence error controlling apparatus of the system includes a first memory storing and outputting the correction data in response to the horizontal and vertical addresses, a second memory for storing and outputting the interpolation data in response to the horizontal and vertical addresses, a counter for receiving vertical and horizontal synchronization signals from the address generator and each line number of the interpolation data from the second memory, counting each line number of the horizontal synchronization signals existing during the period of the vertical synchronization signal by skipping said line number of the horizontal synchronization signals corresponding to the interpolation data, a multiplier for outputting a multiplied output signal by multiplying a counted signal of the counter with the interpolation data transmitted from the second controller in response to an enable signal generated in accordance with the line number of the interpolation data from said second memory, a code bit discriminator for receiving and recognizing the interpolation data from the second memory and outputting an operation signal depending on the status of the interpolation data, and an adder and a subtracter for receiving the correction data from the first memory and the interpolation data from the second memory, adding and subtracting the multiplied output signal of the multiplier in response to the operation signal from the code bit discriminator.

The digital dynamic convergence error control apparatus includes a nonvolatile external memory storing correction data and interpolation data for correcting convergence errors corresponding to crossing points of a screen pattern, a controller receiving said correction data and the interpolation data from the nonvolatile external memory through a data bus and an address bus, generating control signals for proceeding a convergence error correcting and interpolating processes for each portion of the screen pattern, a reference clock generator generating clock signals in response to a clock control signal inputted from the controller, an address generator generating an interrupt signal and setup signals for calculating the interpolation data corresponding to an area disposed between adjacent crossing points in response to horizontal and vertical synchronization signals extracted from the picture signal, control signals generated from the controller, and said clock signals generated from the reference clock generator, an internal memory storing the correction data and the interpolation data inputted into the controller, and an output section converting the correction data and the interpolation data into the voltage and the current in response to output control signals generated from the controller and a conversion control signal generated from the address generator, and applying the voltage and the current to the magnetic field controlling coils for generating more than two pole magnetic fields.

The digital dynamic convergence error control apparatus is made of a single semiconductor chip in a monolithic structure excluding the nonvolatile external memory.

The crossing points of the screen pattern correspond to respective correction data and are formed by horizontal lines and vertical lines.

The interpolation data is generated in an area disposed between the adjacent crossing points of the screen pattern, the area corresponding to horizontal synchronization signals of the picture signal disposed between the adjacent crossing points of the screen pattern, the crossing points of the screen pattern being formed by horizontal lines and vertical lines.

The control signals of the controller include a skip number, a first dividing ratio, a pass number, and a second dividing ratio, a first comparator clock number, and a main clock signal transmitted to the reference clock generator.

The setup signals of the address generator include an NCNT signal, a horizontal address, a vertical address, a horizontal control signal, and a vertical control signal.

The controller generates the control signals by counting the number of the clock signals generated from the reference clock generator during a period of a horizontal synchronization signal of the picture signal in response to the clock control signal of the controller. The address generator of the digital dynamic convergence error control apparatus includes a first counter and a first comparator generating the NCNT signal as one of setup signals in response to the number of the clock signals counted during the period of the horizontal synchronization signal, generating a first interrupt signal whenever there exists a difference between the NCNT and a reference, a first divider receiving a skip number and a first dividing ratio, generating a horizontal control signal as one of said setup signals after dividing by the first dividing ratio a remaining portion of the horizontal synchronization signal remained after skipping the horizontal synchronization signal by a number of clock signals corresponding to the skip number, a second counter generating horizontal address signal by counting the horizontal control signal generated from the first divider, a second divider receiving a pass number and a second dividing ratio and generating a vertical control signal after dividing by the second dividing ratio a remaining portion of the vertical synchronization signal remained after passing a number of horizontal synchronization signals corresponding to the pass number during the vertical synchronization signal, a third counter generating a vertical address signal by counting the vertical control signal generated from the second divider, a fourth counter generating a count value by counting the number of clocks of the horizontal synchronization signal during a vertical synchronization signal period, and a second comparator receiving the count value generated from fourth counter, outputting a second interrupt signal whenever a difference between the count value and a second reference by counting the number of clocks in every vertical synchronization signal only when the first comparator generates the first interrupt signal.

The output section of the digital dynamic convergence error control apparatus includes a plurality of digital to analog converters converting into each analog signal the correction data and the interpolation data corresponding to respective magnetic field correcting coils generating more than two pole magnetic fields corresponding to respective vertical and horizontal axes of the magnetic field correcting coils. The output section includes a plurality of correction and interpolation sections coupled to respective the digital to analog converters, receiving the correction data and the interpolation data from the internal memory, transmitting the correction data and the interpolation data to corresponding digital to analog converter so as to control respective magnetic field controlling coils designated by each coil address generated from the address generator with corresponding correction data and the interpolation data.

The digital dynamic convergence error control apparatus includes a correction and interpolation section having a first memory storing and outputting the correction data in response to the horizontal and vertical address, a second memory storing and outputting the interpolation data in response to the horizontal and vertical address, a counter for receiving vertical and horizontal synchronization signals from the address generator and each line number of the interpolation data from the second memory, counting each line number of the horizontal synchronization signals existing during the vertical control signal by skipping the line number of the horizontal synchronization signals corresponding to the interpolation data, a multiplier for outputting a multiplied output signal by multiplying a counted signal of the counter with the interpolation data transmitted from the second controller in response to an enable signal generated in accordance with the line number of the interpolation data from the second memory, a code bit discriminator for receiving and recognizing the interpolation data from the second memory, outputting an operation signal depending on the status of the interpolation data, and an adder and a subtracter for receiving the correction data from the first memory and the interpolation data from the second memory, adding and subtracting the multiplied output signal of the multiplier in response to the operation signal from the code bit discriminator.

A deflection yoke having a digital dynamic convergence error correcting apparatus includes a coil separator having a neck portion coupled to a CRT, a horizontal deflection coil and a vertical deflection coil provided on the coil separator, a plurality of magnetic field controlling coils for generating more than two pole magnetic fields, a non-volatile external memory storing correction data and interpolation data for correcting convergence errors corresponding to crossing points of a screen pattern, a controller receiving the correction data and the interpolation data from the non-volatile external memory through a data bus and an address bus, generating control signals for proceeding a convergence error correcting and interpolating processes for each portion of the screen pattern, a reference clock generator generating clock signals in response to a clock control signal inputted from the controller, an address generator generating an interrupt signal and setup signals for calculating the interpolation data corresponding to an area between adjacent crossing points in response to horizontal and vertical synchronization signals extracted from the picture signal, control signals generated from the controller, and the clock signals generated from the reference clock generator, an internal memory storing the correction data and the interpolation data inputted into the controller, and an output section converting the correction data and the interpolation data into the voltage and the current in response to output control signals generated from the controller and a conversion control signal generated from the address generator, and applying the voltage and the current to the magnetic field controlling coils for generating more than two pole magnetic fields.

In the deflection yoke having a digital dynamic convergence error correcting apparatus, the controller, the reference clock generator, the address generator, the internal memory, and the output section all are integrated in a single semiconductor chip having a monolithic structure.

In the deflection yoke having a digital dynamic convergence error correction apparatus, the crossing points of the screen pattern correspond to respective correction data and being formed by horizontal lines and vertical lines.

In the deflection yoke having a digital dynamic convergence error correcting apparatus, the

interpolation data generated in an area disposed between the adjacent crossing points of the screen pattern, the area corresponding to horizontal synchronization signals of the picture signal disposed between the adjacent crossing points of the screen pattern, the crossing points of the screen pattern being formed by horizontal lines and vertical lines.

The control signals of the controller in the deflection yoke having a digital dynamic convergence error correcting apparatus include a skip number, a first dividing ratio, a pass number, and a second dividing ratio, a first comparator clock number, and a main clock signal transmitted to the reference clock generator.

The setup signals of the address generator in the deflection yoke having a digital dynamic convergence error correcting apparatus include a NCNT signal, a horizontal address, a vertical address, a horizontal control signal, and a vertical control signal.

The controller of the deflection yoke having the digital dynamic convergence error correcting apparatus generates the control signals by counting the number of the clock signals generated from the reference clock generator during a period of a horizontal synchronization signal of the picture signal in response to the clock control signal of the controller. The address generator of the deflection yoke having the digital dynamic convergence error control apparatus includes a first counter and a first comparator generating an NCNT signal as one of setup signals in response to the number of the clock signals counted during the period of the horizontal synchronization signal, generating a first interrupt signal whenever there exists a difference between the NCNT and a reference, a first divider receiving a skip number and a first dividing ratio, generating a horizontal control signal as one of the setup signals after dividing by the first dividing ratio a remaining portion of the horizontal synchronization signal remained after skipping the horizontal synchronization signal by a number of clock signals corresponding to the skip number, a second counter generating horizontal address signal by counting the horizontal control signal generated from the first divider, a second divider receiving a pass number and a second dividing ratio and generating a vertical control signal after dividing by the second dividing ratio a remaining portion of the vertical synchronization signal remained after passing a number of horizontal synchronization signals corresponding to the pass number during the vertical synchronization signal, a third counter generating a vertical address signal by counting the vertical control signal generated from the second divider, a fourth counter generating a count value by counting the number of clocks of the horizontal synchronization signal during a vertical synchronization signal period, and a second comparator receiving the count value generated from fourth counter, outputting a second interrupt signal whenever a difference between the count value and a second reference by counting the number of clocks in every vertical synchronization signal only when the first comparator generates the first interrupt signal.

The output section of the deflection yoke having the digital dynamic convergence error correcting apparatus includes a plurality of digital to analog converters converting into each analog signal the correction data and the interpolation data corresponding to respective magnetic field correcting coils generating more than two pole magnetic fields corresponding to respective vertical and horizontal axes of the magnetic field correcting coils, and a plurality of correction and interpolation sections coupled to respective the digital to analog converters, receiving the correction data and the interpolation data from the internal memory, transmitting the correction data and the interpolation data to corresponding digital to analog converter so as to control respective magnetic field controlling coils designated by each coil address generated from the address generator with corresponding correction data and the interpolation data.

The deflection yoke having the digital dynamic convergence error correcting apparatus includes a correction and interpolation section having a first memory storing and outputting the correction data in response to the horizontal and vertical address, a second memory storing and outputting the interpolation data in response to the horizontal and vertical address, a counter for receiving vertical and horizontal synchronization signals from the address generator and each line number of the interpolation data from the second memory, counting each line number of the horizontal synchronization signals existing during the vertical control signal by skipping the line number of the horizontal synchronization signals corresponding to the interpolation data, a multiplier for outputting a multiplied output signal by multiplying a counted signal of the counter with the interpolation data transmitted from the second controller in response to an enable signal generated in accordance with the line number of the interpolation data from the second memory,

a code bit discriminator for receiving and recognizing the interpolation data from the second memory, outputting an operation signal depending on the status of the interpolation data, and an adder and a subtracter for receiving the correction data from the first memory and the interpolation data from the second memory, adding and subtracting the multiplied output signal of the multiplier in response to the operation signal from the code bit discriminator.

A display device having a digital dynamic convergence error correcting apparatus includes a deflection yoke deflecting electron beams emitted from a electron gun of a CRT, a plurality of magnetic field controlling coils for generating more than two pole magnetic fields, a non-volatile external memory storing correction data and interpolation data for correcting convergence errors corresponding to crossing points of a screen pattern, a controller receiving the correction data and the interpolation data from the non-volatile external memory through a data bus and an address bus, generating control signals for proceeding a convergence error correcting and interpolating process for each portion of the screen pattern, a reference clock generator generating clock signals in response to a clock control signal inputted from the controller, an address generator generating an interrupt signal and setup signals for calculating the interpolation data corresponding to an area between adjacent crossing points in response to horizontal and vertical synchronization signals extracted from the picture signal, control signals generated from the controller, and the clock signals generated from the reference clock generator, an internal memory storing the correction data and the interpolation data inputted into the controller, and an output section converting the correction data and the interpolation data into the voltage and the current in response to output control signals generated from the controller and a conversion control signal generated from the address generator, and applying the voltage and the current to the magnetic field controlling coils for generating more than two pole magnetic fields.

In the display device having a digital dynamic convergence error correcting apparatus, the controller, the reference clock generator, the address generator, the internal memory, and the output section all being integrated in a single semiconductor chip having a monolithic structure.

In the display device having a digital dynamic convergence error correcting apparatus, the crossing points of the screen pattern correspond to respective correction data and being formed by horizontal lines and vertical lines.

In the display device having a digital dynamic convergence error correcting apparatus, the

interpolation data is generated in an area disposed between the adjacent crossing points of the screen pattern, the area corresponding to horizontal synchronization signals of the picture signal disposed between the adjacent crossing points of the screen pattern, the crossing points of the screen pattern being formed by horizontal lines and vertical lines. the convergence error correction data being corresponding to respective crossing points of the screen pattern being formed by horizontal lines and vertical lines.

In the display device having a digital dynamic convergence error correcting apparatus, the control signals of the controller includes a skip number, a first dividing ratio, a pass number, and a second dividing ratio, a first comparator clock number, and a main clock signal transmitted to the reference clock generator.

In the display device having a digital dynamic convergence error correcting apparatus, the setup signals of the address generator include an NCNT signal, a horizontal address, a vertical address, a horizontal control signal, and a vertical control signal.

The controller of the display device having a digital dynamic convergence error correcting apparatus generates the control signals by counting the number of the clock signals generated from the reference clock generator during a period of a horizontal synchronization signal of the picture signal in response to the clock control signal of the controller. The address generator of digital dynamic convergence error control apparatus includes a first counter and a first comparator generating the NCNT signal as one of setup signals in response to the number of the clock signals counted during the period of the horizontal synchronization signal, generating a first interrupt signal whenever there exists a difference between the NCNT and a reference, a first divider receiving a skip number and a first dividing ratio, generating a horizontal control signal as one of the setup signals after dividing by the first dividing ratio a remaining portion of the horizontal synchronization signal remained after skipping the horizontal synchronization signal by a number of clock signals corresponding to the skip number, a second counter generating horizontal address signal by counting the horizontal control signal generated from the first divider, a second divider receiving a pass number and a second dividing ratio and generating a vertical control signal after dividing by the second dividing ratio a remaining portion of the vertical synchronization signal remained after passing a number of horizontal synchronization signals corresponding to the pass number during the vertical synchronization signal, a third counter generating a vertical address signal by counting the vertical control signal generated from the second divider, a fourth counter generating a count value by counting the number of clocks of the horizontal synchronization signal during a vertical synchronization signal period, and a second comparator receiving the count value generated from fourth counter, outputting a second interrupt signal whenever a difference between the count value and a second reference by counting the number of clocks in every vertical synchronization signal only when the first comparator generates the first interrupt signal.

The output section of the display device having a digital dynamic convergence error correcting apparatus includes a plurality of digital to analog converters converting into each analog signal the correction data and the interpolation data corresponding to respective magnetic field correcting coils generating more than two pole magnetic fields corresponding to respective vertical and horizontal axes of the magnetic field correcting coils, and a plurality of correction and interpolation sections coupled to respective the digital to analog converters, receiving the correction data and the interpolation data from the internal memory, transmitting the correction data and the interpolation data to corresponding digital to analog converter so as to control respective magnetic field controlling coils designated by each coil address generated from the address generator with corresponding correction data and the interpolation data.

The display device having a digital dynamic convergence error correcting apparatus includes a correction and interpolation section having a first memory storing and outputting the correction data in response to the horizontal and vertical address, a second memory storing and outputting the interpolation data in response to the horizontal and vertical address, a counter for receiving vertical and horizontal synchronization signals from the address generator and each line number of the interpolation data from the second memory, counting each line number of the horizontal synchronization signals existing during the vertical control signal by skipping the line number of the horizontal synchronization signals corresponding to the interpolation data, a multiplier for outputting a multiplied output signal by multiplying a counted signal of the counter with the interpolation data transmitted from the second controller in response to an enable signal generated in accordance with the line number of the interpolation data from the second memory, a code bit discriminator for receiving and recognizing the interpolation data from the second memory, outputting an operation signal depending on the status of the interpolation data, and an adder and a subtracter for receiving the correction data from the first memory and the interpolation data from the second memory, adding and subtracting the multiplied output signal of the multiplier in response to the operation signal from the code bit discriminator.

An apparatus for generating a convergence reference signal for correcting convergence errors in a picture displayed on a screen of a CRT by controlling a plurality of magnetic field controlling coils for generating more than two pole magnetic fields corresponding to one of horizontal and vertical axes includes a controller generating control signals including a skip number, a pass number, a first dividing ratio, a second dividing ratio, and clocks, a first counter and a first comparator generating a counted number by counting the number of the clocks during a period of a horizontal synchronization signal, generating a first interrupt signal whenever there exists a difference between the counted number and a reference number, a first divider receiving the skip number and the first dividing ratio, subtracting the number of the clocks corresponding to the skip number from the period of the horizontal synchronization signal, dividing a remaining period of the subtracted horizontal synchronization signal by the first dividing ratio, and generating a horizontal control signal, a second counter generating a horizontal address signal by counting the horizontal control signal generated from the first divider, a second divider receiving the second dividing ratio and the pass number representing that a number of horizontal synchronization signals are eliminated, subtracting the number of horizontal synchronization signals corresponding to the pass number from a total number of horizontal synchronization signals during a period of the vertical synchronization signal, dividing a remaining number of the horizontal synchronization signals of the vertical synchronization signal by the second dividing ratio, and generating a vertical control signal, a third counter generating a vertical address signal by counting the vertical control signal, a fourth counter generating a count value by counting the number of clocks of the horizontal synchronization signal during a vertical synchronization signal period, and a second comparator receiving the count value generated from the fourth counter and outputting a second interrupt signal whenever a difference between the count value and a reference value in every vertical synchronization signal only when the first comparator generates the first interrupt signal.

In the apparatus for generating a convergence reference signal for correcting convergence errors in the picture displayed on the screen of the CRT, the convergence reference signal for correcting convergence errors in a picture displayed on a screen of a CRT is generated in response to the control signals by reading correction data and interpolation data stored in a memory coupled to the apparatus in accordance with the number of the clocks counted during the period of the horizontal synchronization signal.

In a digital dynamic convergence error correcting apparatus having an address generator for generating a convergence error correction reference point address for correcting convergence errors of a picture displayed in a screen of a CRT and an interpolating apparatus for performing a convergence error correcting and interpolating process by controlling respective magnetic field controlling coils corresponding to vertical and horizontal axes, a correcting and interpolating apparatus includes a first memory storing and outputting the correction data in response to the horizontal and vertical address, a second memory storing and outputting the interpolation data in response to the horizontal and vertical address, a counter for receiving vertical and horizontal synchronization signals from the address generator and each line number of the interpolation data from the second memory, counting each line number of the horizontal synchronization signals existing during the vertical control signal by skipping the line number of the horizontal synchronization signals corresponding to the interpolation data, a multiplier for outputting a multiplied output signal by multiplying a counted signal of the counter with the interpolation data transmitted from the second controller in response to an enable signal generated in accordance with the line number of the interpolation data from the second memory, a code bit discriminator for receiving and recognizing the interpolation data from the second memory, outputting an operation signal depending on the status of the interpolation data, and an adder and a subtracter for receiving the correction data from the first memory and the interpolation data from the second memory, adding and subtracting the multiplied output signal of the multiplier in response to the operation signal from the code bit discriminator.

In the interpolating apparatus of the digital dynamic convergence error correcting apparatus, an area for correcting the convergence error in accordance with the correction data outputted from the first memory corresponds to respective correction points of the screen indicated by respective convergence error correction reference point addresses.

In the interpolating apparatus of the digital dynamic convergence error correcting apparatus, an area for being interpolated in accordance with the interpolation data outputted from the second memory corresponds to the horizontal synchronization signals disposed between correction points indicated by respective adjacent convergence error correction reference point addresses.

### BRIEF DESCRIPTION OF THE INVENTION

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic diagram showing a conventional convergence correction data generator;

FIG. 2 is a diagram of the convergence correction data generator of FIG. 1;

FIG. 3 is a reference screen pattern adapted for use in the convergence correction data generator of FIG. 2;

FIGS. 4 through 9 are diagrams showing two pole magnetic fields, four pole magnetic fields, and six pole magnetic fields operated in eight coil structure adapted for use in a dynamic convergence correcting apparatus;

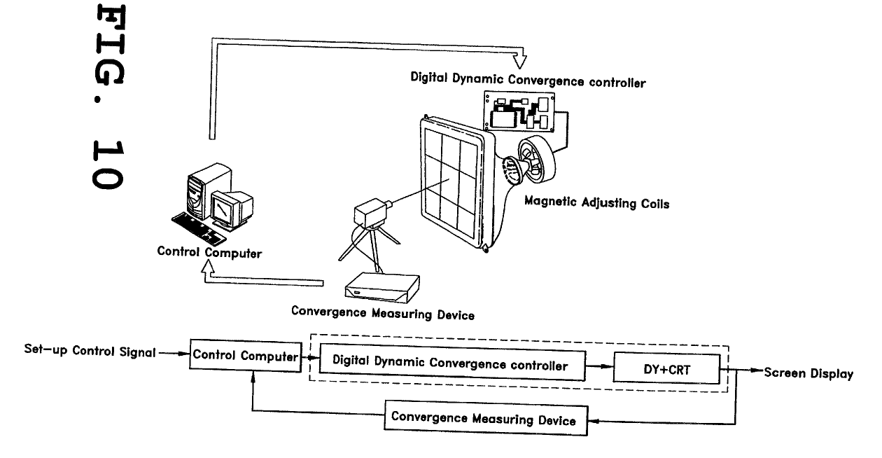

FIG. 10 is a schematic diagram showing a system adapted for use in a digital dynamic convergence control method;

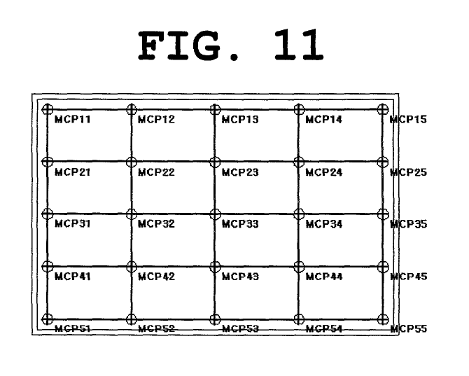

FIG. 11 is a reference screen pattern adapted for use in the digital dynamic convergence control method;

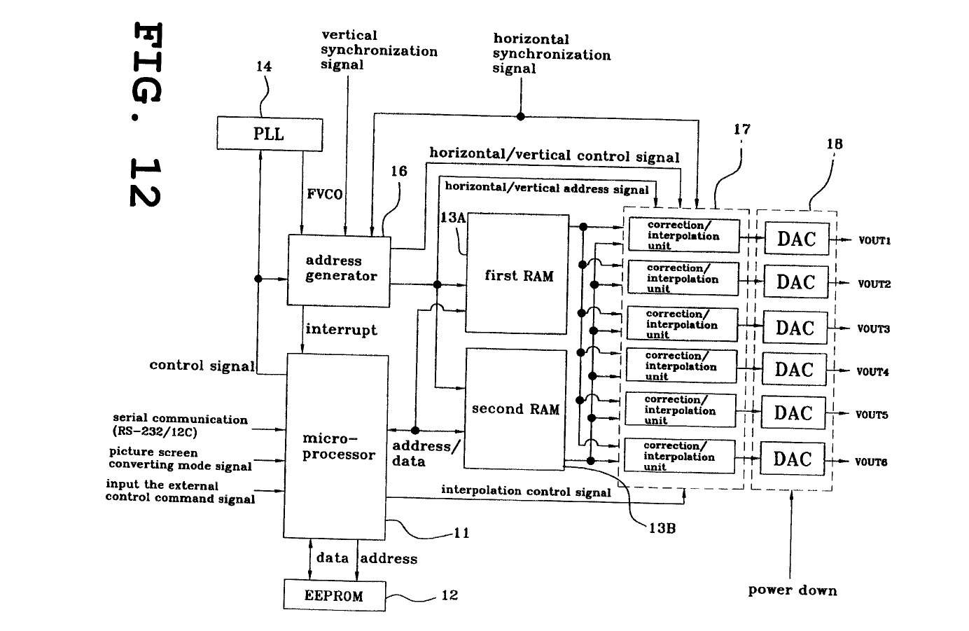

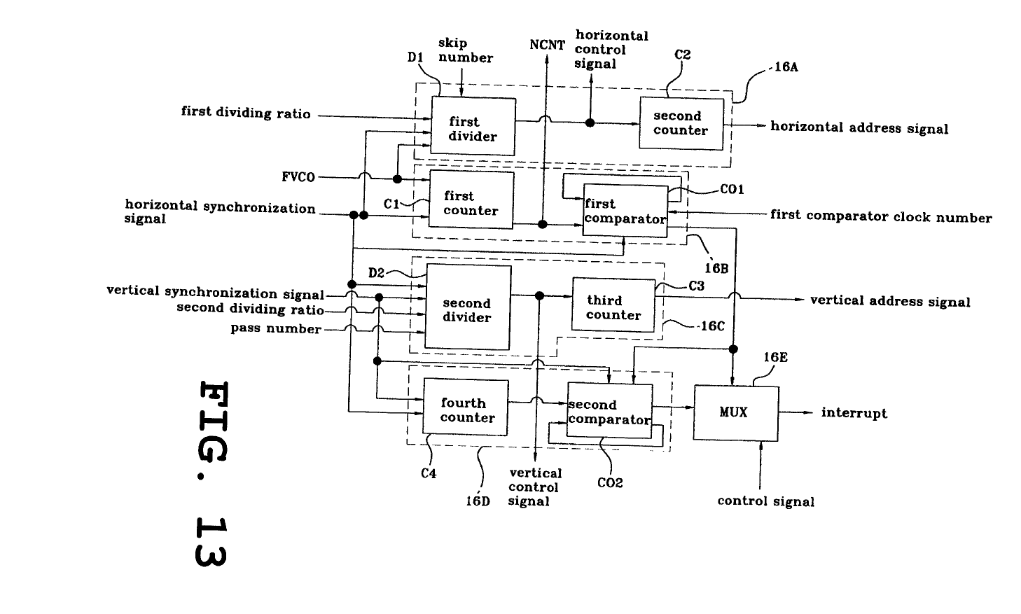

FIG. 12 is a block diagram showing a digital dynamic convergence control system in a CRT display device;

FIG. 13 is a block diagram of an address generator of FIG. 12;

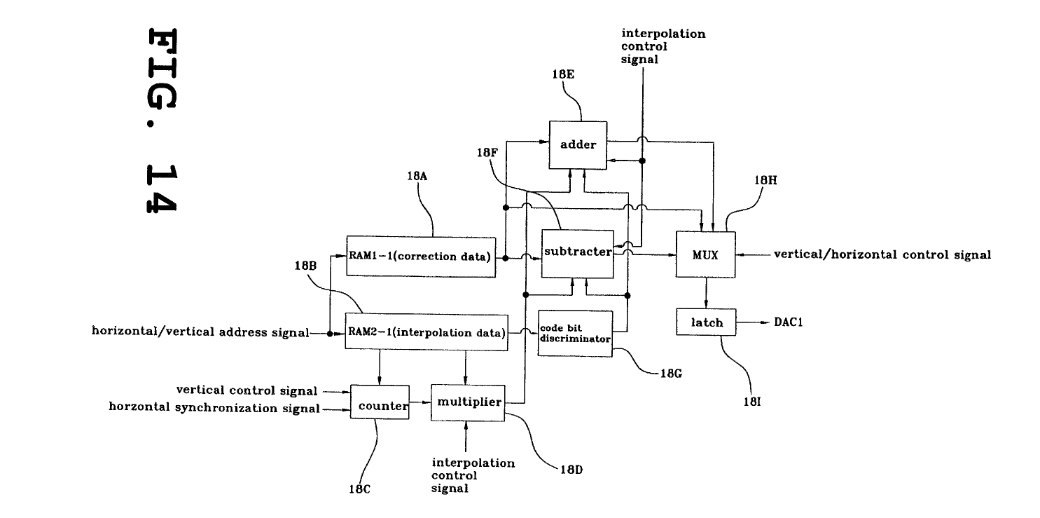

FIG. 14 is a block diagram of a correction and interpolation circuit of FIG. 12;

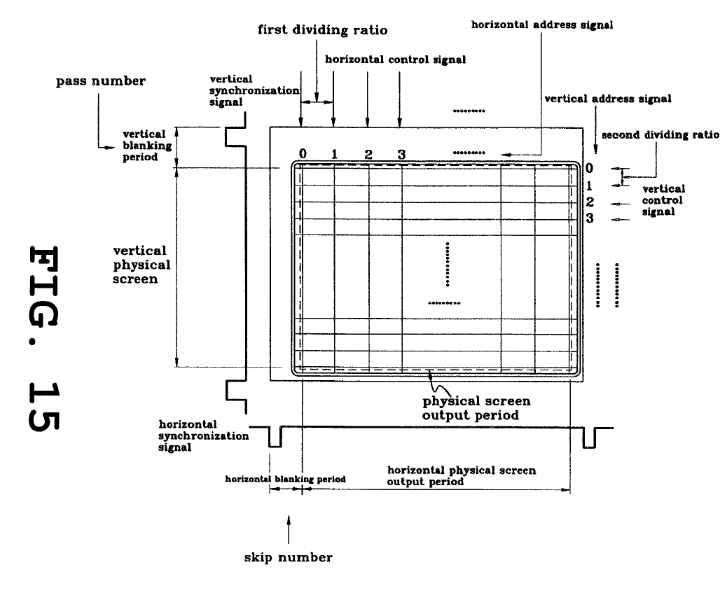

FIG. 15 is a schematic diagram useful for explaining both the reference screen pattern and each definition of terms of the digital dynamic convergence control system;

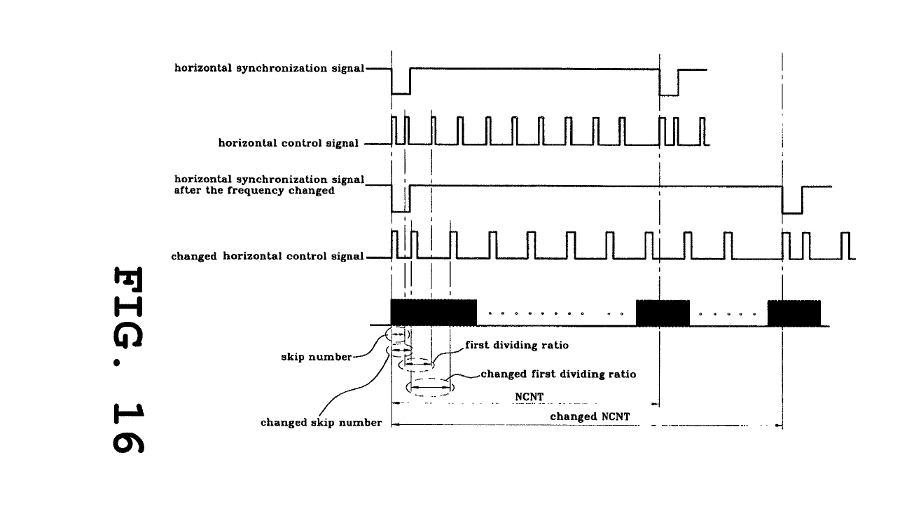

FIGS. 16A through 16E are waveforms showing a horizontal correction operation;

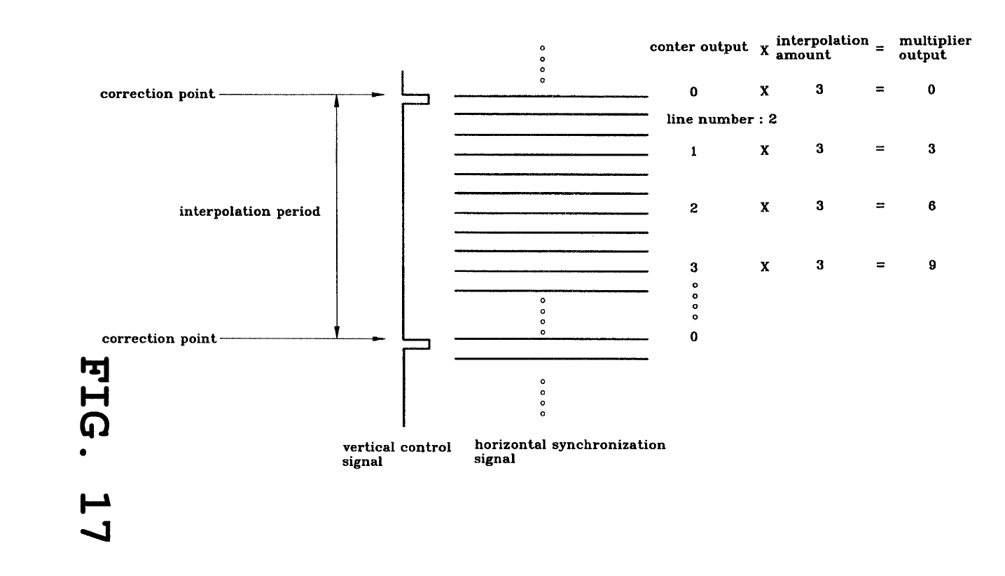

FIG. 17 is a diagram showing a vertical interpolation;

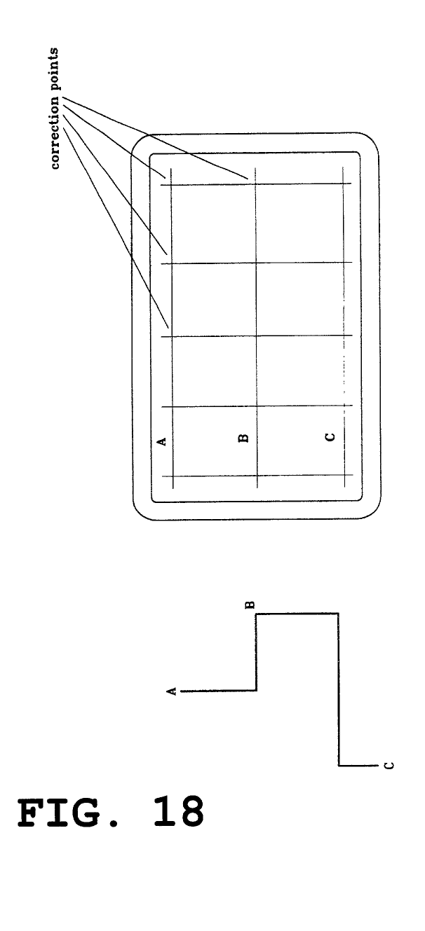

FIG. 18 is a diagram showing pixels for interpolation in the reference screen pattern;

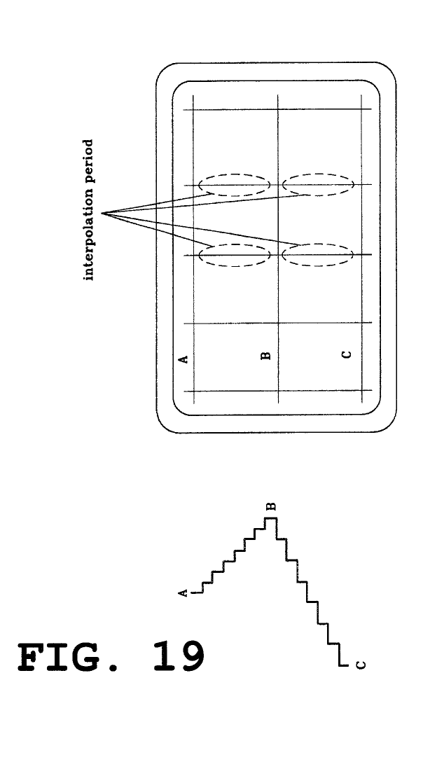

FIG. 19 is a diagram showing intervals for interpolation in the reference screen pattern;

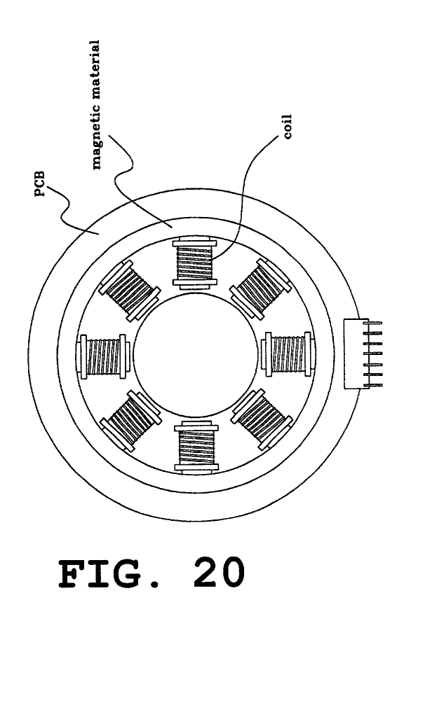

FIG. 20 is a schematic diagram of a magnetic field control yoke device;

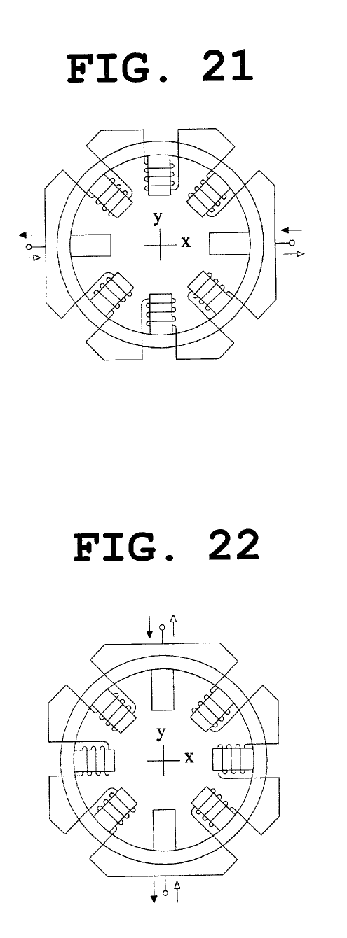

FIG. 21 is a diagram showing coils for generating two pole magnetic fields having a horizontal axis in the magnetic field control yoke device of FIG. 20;

FIG. 22 is a diagram showing coils for generating two pole magnetic fields having a vertical axis in the magnetic field control yoke device of FIG. 20;

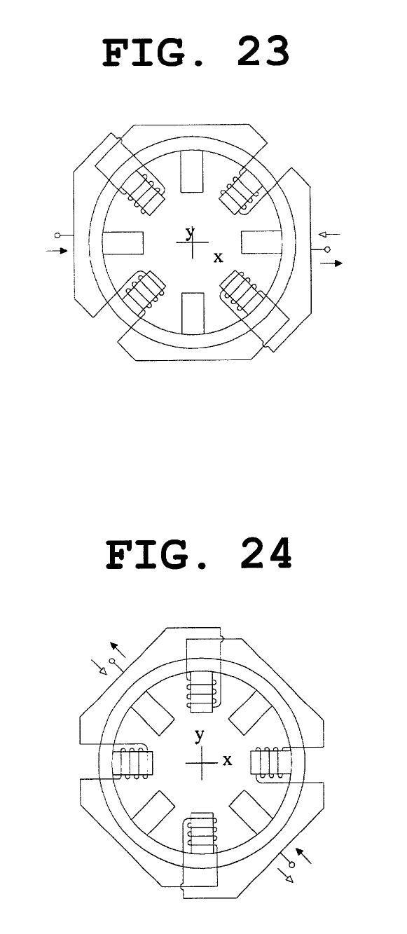

FIG. 23 is a diagram showing coils for generating four pole magnetic fields having a horizontal axis in the magnetic field control yoke device of FIG. 20;

FIG. 24 is a diagram showing coils for generating four pole magnetic fields having a vertical axis in the magnetic field control yoke device of FIG. 20;

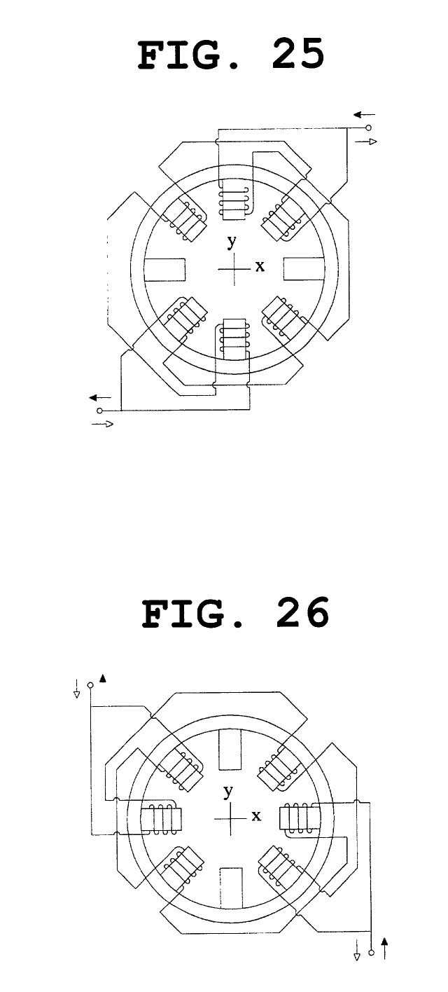

FIG. 25 is a diagram showing coils for generating six pole magnetic fields having a horizontal axis in the magnetic field control yoke device of FIG. 20;

FIG. 26 is a diagram showing coils for generating six pole magnetic fields having a vertical axis in the magnetic field control yoke device of FIG. 20;

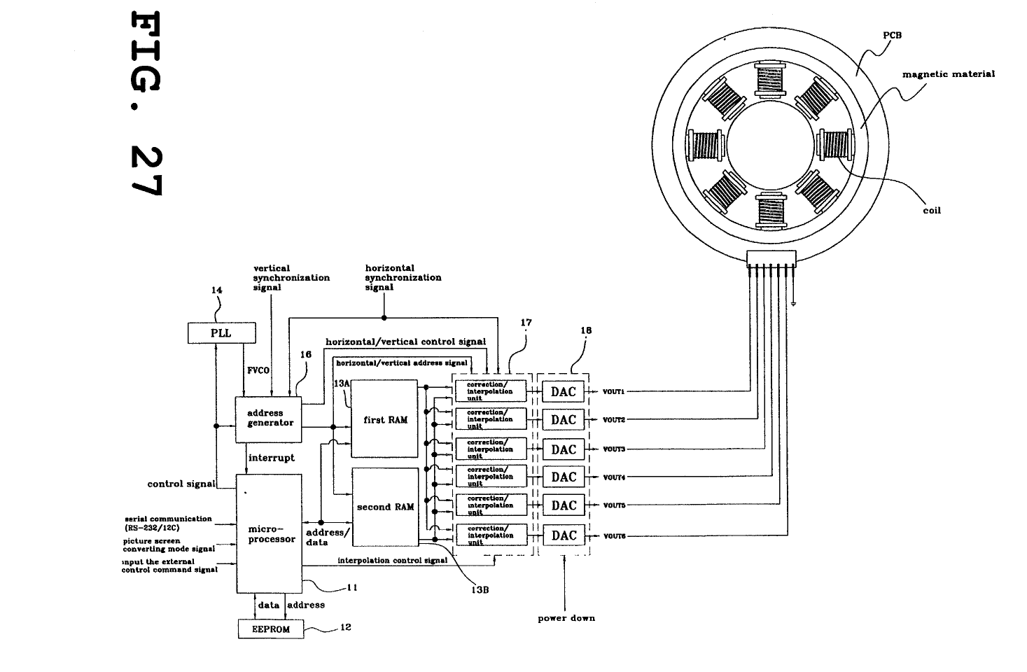

FIG. 27 is a schematic diagram showing a magnetic field control yoke device coupled to the digital convergence control system constructed according to the principles of the present invention; and

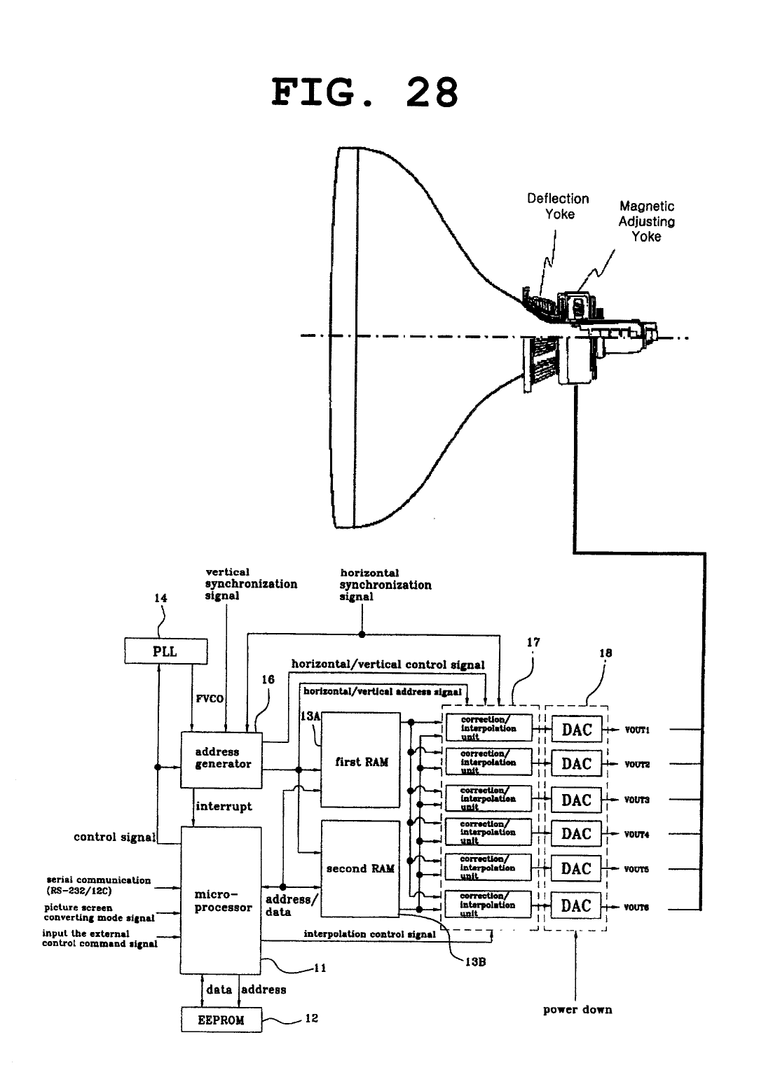

FIG. 28 is a schematic diagram showing a deflection yoke and CRT of a display device coupled to the digital convergence control system constructed according to the principles of the present invention.

### DETAIL DESCRIPTION OF THE INVENTION

The conventional convergence error controller, predetermined types of current waves are applied for the entire picture screen in response to the convergence error using magnetic field correcting coils for generating two pole, four pole, and six pole magnetic fields as shown each of FIGS. 4 through 9. However, in the present invention, when each divided area of the picture screen is independently compensated by independent convergence error, the respective areas contained in each field of a picture screen having 60 fields per a second, the areas are corrected independently from each other with respective independent and variable convergence errors.

Since a plurality of independent convergence errors are corresponding to respective areas in a single field of the picture screen, the respective areas are corrected only with the corresponding convergence errors which do not affect other areas. Therefore, very high resolution for a picture quality is achieved by the independent convergence error correcting signals only for the respective areas.

In the conventional methods, although the convergence error is corrected throughout the entire picture screen, there still exists a convergence error in a specific area of the picture screen. If a convergence error of an area of the picture screen is corrected by a convergence error correction signal, the other area of the picture screen of which convergence error has been already corrected shows another convergence error because of the convergence error correction signal affecting the other area. Moreover, if a convergence error correcting signal is applied to the deflecting yoke to correct the convergence error in a specific area, another convergence error is incurred in another area because the convergence error affects another area which does not have the same amount of the convergence error while the specific convergence error of the specific area might be corrected by the convergence error correcting signal.

Although it is disadvantageous that all area of the entire picture screen may not be corrected in the conventional method, on the contrary, the present invention provides respective independent convergence error correcting signals corresponding to each of specific areas in the field of the picture screen without affecting adjacent or other areas. This improvement features makes the convergence error correcting system in a one chipset, light in weight, and slim in size.

FIGS. 4 through 9 shows the state of deflection force affecting each of RGB electron beams when correcting current is applied to magnet fields correcting coils for generating two pole magnetic fields, four pole magnetic fields, and six pole magnetic fields in accordance with convergence error correcting signals.

FIG. 4 shows horizontal two pole magnetic field correcting coils and deflection directions of each of RGB electron beams in response to convergence error correcting current applied to magnetic field correcting coils for generating two pole magnetic fields. All of the RGB electron beams move in the same horizontal direction.

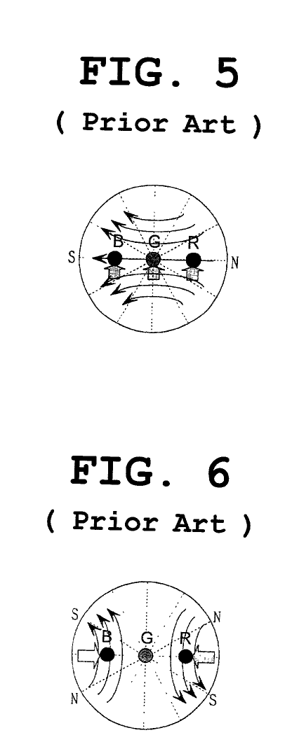

FIG. 5 shows vertical two pole magnetic field correcting coils and deflection directions of each of RGB electron beams in response to convergence error correcting current applied to magnetic field correcting coils for generating two pole magnetic fields. All of the RGB electron beams move in the same vertical direction.

FIG. 6 shows horizontal four pole magnetic field correcting coils and deflection directions of each of RGB electron beams in response to convergence error correcting current applied to magnetic field correcting coils for generating four pole magnetic fields. R and B electron beams move in the opposite horizontal direction.

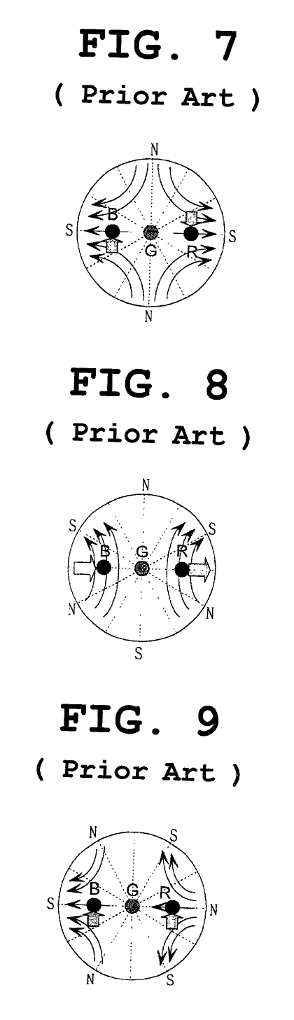

FIG. 7 shows vertical four pole magnetic field correcting coils and deflection directions of each of RGB electron beams in response to convergence error correcting current applied to magnetic field correcting coils for generating four pole magnetic fields. R and B electron beams move in the opposite vertical direction.

FIG. 8 shows horizontal six pole magnetic field correcting coils and deflection directions of each of RGB electron beams in response to convergence error correcting current applied to magnetic field correcting coils for generating six pole magnetic fields. R and B electron beams move in the same horizontal direction.

FIG. 9 shows vertical six pole magnetic field correcting coils and deflection directions of each of RGB electron beams in response to convergence error correcting current applied to magnetic field correcting coils for generating six pole magnetic fields. R and B electron beams move in the same vertical direction.

Since the amount of deflection force for the RGB electron beams varies in dependence on the convergence error correcting current, it is needed to control the convergence error correcting current for correcting the respective convergence errors. As described above, a combination of magnetic field correcting coils for generating two pole, four pole, and six pole magnetic fields in a horizontal direction and a vertical direction is generally called a convergence yoke adapted for use in a magnetic field adjusting means.

FIG. 10 is a schematic diagram showing a convergence error detecting and correcting system adapted for use in a digital dynamic convergence control method. A convergence detecting apparatus detects a reference screen pattern displayed on a screen of a CRT having a magnetic field controlling coils mounted on a deflection yoke DY. A main control means having a control computer is coupled to the convergence detecting apparatus and a digital dynamic convergence error correcting apparatus. The CRT and the deflection yoke DY are coupled to the digital dynamic convergence error correcting apparatus. A setup control signal is inputted to the control computer.

The digital dynamic convergence error controlling apparatus stores convergence error correction data corresponding to each crossing point (correction point) of the screen pattern into respective predetermined addresses of a memory, produces reading addresses of the memory for reading the convergence error correction data corresponding to crossing points (correction points) when each of said correction points is scanned in response to horizontal and vertical synchronization signals obtained from a picture signal to be displayed in a CRT display device, independently reads each of the convergence error correction data from the memory in response to the respective reading address, and controls the magnetic field controlling coils after the convergence error correction data is amplified and converted into a control voltage signal or a control current signal.

The convergence error correcting data corresponding to respective correction points of the screen pattern as shown in FIG. 11 represents the control voltage signal or the control current signal which is applied to each of the two pole, four pole, or six pole magnetic field controlling coils as shown in FIG. 10, the convergence error correction data is transmitted to the digital dynamic convergence error controlling apparatus after computed from the amount of the convergence error occurred in the correction points of the screen pattern detected by the convergence error detecting apparatus using a control logic and a beam trace analysis method.

The predetermined and reading addresses for storing the convergence error correction data in the memory and for reading the convergence error correction data from the memory includes a combination of a vertical position number of each correction point, a horizontal position number of the each correction point, a specific number for designating the magnetic field controlling coils receiving the control voltage signal or the control current signal corresponding to each correction point. With these features, the convergence error of each correction point is independently adjusted and controlled without affecting other correction points of the screen pattern.

The correction points MCP11 through MCP55 are controlled independently from each other as shown in FIG. 11 using the above features constructed according to the principles of the present invention. Regarding to each of the correction points, all of the control voltage signal or the control current signal applied to each of two pole, four pole, and six pole magnetic field controlling coils as shown in FIGS. 4 through 9 are controlled and adjusted to independently correct the convergence error corresponding to the respective correction points. The convergence errorr of the RGB electron beams are independently controlled to a certain state by using operation principles of the magnetic field controlling coils. The operation principles of the magnetic field controlling coils are the substantially same as a convergence purity magnet mounted on a neck portion of the deflection yoke.

The digital dynamic convergence error control system includes the convergence error detecting apparatus, a main control means, and a digital dynamic convergence error correcting apparatus all forming a closed loop. The closed loop repeats operations of the above convergence error detecting process until a desired convergence error correction data corresponding to the correction points is obtained during the repeated convergence error detecting process. If the desired convergence error correction is obtained, each of the convergence error correcting data corresponding to the respective correction points is stored in a EEPROM of the memory contained in a controller of the digital dynamic convergence error correcting apparatus. After the correction data is stored in the EEPROM, the digital dynamic convergence error correcting apparatus contained in a dotted line of FIG. 10 is operated independently from the convergence error detecting apparatus and the main control means.

After the convergence error correcting process is completed, a CRT structure combined with the digital dynamic convergence error correcting apparatus, the magnetic field controlling coils, the deflection yoke, and the CRT display device are detached from the digital dynamic convergence error control system. When power is supplied to the CRT structure, a controller of the digital dynamic convergence error controlling apparatus reads the convergence error correction data from the EEPROM and performs a convergence error correcting process in an open loop.

Since the convergence error correction data obtained from the repeated convergence error detecting process is determined in an external control computer disposed outside the digital dynamic convergence error controlling apparatus, an internal microprocessor of the digital dynamic convergence error controlling apparatus performs a couple of operations, such as a data transmission process and a data storing process other than a convergence error detecting process and a convergence error correction signal determining process. Thus, the digital dynamic convergence error controlling apparatus is not required to have any additional memory and processor. Since the digital dynamic convergence error controlling apparatus is required to have only output functions of the convergence error correction data without performing the convergence error detecting process and the convergence error correction signal determining process for computing the convergence error correction data in a real time and in accordance with a scanning period of the crossing points of the screen pattern, the implementation of the digital dynamic convergence error controlling apparatus becomes simple.

A more detail structure and operation of the digital dynamic convergence error controller are described in FIG. 12 as follows.

FIG. 12 is a block diagram showing a digital dynamic convergence error controlling apparatus in a CRT display device. All of functional modules except reference numeral 12 may be integrated in a one chip having a monolithic structure. The apparatus includes a controller having a microprocessor, a storage having an EEPROM 12 and a pair of RAM 13A, 13B, a readout address generator having a phase locked loop (PLL) 14 and an address generator 16, and an output section having a correction and interpolation unit 17 and a digital to analog converter 18.

The digital dynamic convergence error correcting apparatus includes a FIRM mode, a HOME mode, and a TEST mode in response to a control command signal.

The microprocessor 11 of the controller of the digital dynamic convergence error correcting apparatus in response to the control command signal makes a determination of whether an operation mode of the digital dynamic convergence error correcting apparatus is the FIRM mode having the closed loop for producing the convergence error correction data and interpolation data, the HOME mode having the open loop for outputting the convergence error correction data and interpolation data stored in a memory or EEPROM 12, and the TEST mode.

In accordance with the determination, If the closed mode is selected, microprocessor 11 of the controller generates a plurality of storage addresses for storing the convergence error correction data and the control command signals transmitted from an external apparatus, controls address generator 16 to transmit the storage addresses to address ports of RAM 13A, 13B in response to an end signal of the control command signals, and stores the convergence error correction data by transmitting the convergence error correction data and a write enable signal to the data ports of RAM 13A, 13B. If the end signal of the control command signals is transmitted after the convergence error correcting process is completed, the convergence error correction data stored in RAM 13A, 13b is stored in EEPROM 12 coupled to the external apparatus.

If the open loop is selected, microprocessor 11 reads the convergence error correction data stored in EEPROM 12 and stores in RAM 13A, 13B. After the convergence error correction data is stored in RAM 13A, 13B, microprocessor 11 generates control signals to allow address generator 16 to output addresses and transmit the addresses to address ports of RAM 13A, 13B, and generate a read signal (RE) to RAM 13A, 13B to read the convergence error correction data from RAM 13A, 13B.

A first RAM 13A and a second RAM 13B store different types of data. The convergence error correction data is stored in first RAM 13A while the interpolation data is stored in second RAM 13B.

The interpolation data is obtained from a difference between the convergence error correcting data corresponding to a first correction point defined by a first point of the crossing points of the screen pattern and the convergence error correcting data corresponding to a second correction point disposed adjacent to the first correction point and disposed below the first correction point. The difference is divided by the number of horizontal scanning lines disposed between the two adjacent correction points in order to produce the interpolation data which is used for increasing and decreasing of the convergence error correction data depending on the number of horizontal scanning lines within a vertical period of the picture screen.

When the end signal of the control command signal is transmitted to microprocessor 11, microprocessor 11 controls address generator 16 to transmit the storage addresses outputted from microprocessor 11 to address ports of RAM 13A, 13B through an address bus and to store the convergence error correction data in RAM 13A and the interpolation data in RAM 13B. If the end signal is inputted, the convergence error correction data and the interpolation data are stored in external EEPROM 12.

If the open loop is selected, microprocessor 11 stores the convergence error correction data and the interpolation data in respective RAM 13A, 13B transmitted from EEPROM 12. After the convergence error correction data and the interpolation data are stored in respective RAM 13A, 13B, control signals are generated to control address generator 16 to transmit readout addresses to address ports of RAM 13A, 13B, and the RE signal is generated to read RAM 13A, 13B.

Address generator 16 outputs the readout addresses for the convergence error correction data and the interpolation data stored in RAM 13A, 13B in accordance with a starting point of each horizontal scanning lines corresponding to each of the correction points in response to horizontal and vertical synchronization signals.

Correction and interpolation unit 17 generates each convergence error correction data and each interpolation data corresponding to line number of horizontal scanning lines included in a vertical scanning period using the convergence error correction data and the interpolation data outputted from respective RAM 13A, 13B in response to the readout addresses of address generator 16.

As described above, the integrated digital dynamic convergence error controlling apparatus includes the three modes: the FIRM mode, the HOME mode, the TEST mode.

In the FIRM mode, microprocessor 11 receives from an external control computer through RS-232C cable or I2C communication bus the control command signals and the data used for the convergence error correcting process and the interpolating process from an external computer through RS-232C cable or I2C bus, stores in response to the control command signals the received data in RAM 13A, 13B or in EEPROM 12 coupled to microprocessor 11 through I2C communication bus or any external communication means, and stores in RAM 13A, 13B the data read out from EEPROM 12. In response to the current mode of the CRT structure through I2C communication bus, the control signals are generated, and in response to the control signals, microprocessor 11 transmits the control signals to address generator 16 and an interpolation control signal to correction and interpolation unit 17.

In the HOME mode, microprocessor 11 reads through I2C communication bus the convergence error correction data and the interpolation data stored in EEPROM 12, stores the convergence error correction data and the interpolation data in RAM 13A, 13B, transmits the control signals to address generator 16 and the interpolation control signal to correction and interpolation unit17, and then receives an interrupt signal generated from address generator 16 and the CRT structure. In response to the interrupt signal transmitted from address generator 16 and the CRT structure, the control signals and the interpolation control signal may be changed.

In the TEST mode, in accordance with a program for the TEST, address generator 16, Ram 113A, 13B, correction and interpolation unit 17, and PLL 14 are tested.

Regardless the above three modes, PLL 14 outputs clock signals in the range of 20 MHz and 280 MHz in response to a frequency selection signal generated from microprocessor 11.

After one of the three modes has been selected, the predetermined operation corresponding to the selected mode is performed. When the operation for the selected mode is completed, the predetermined addresses and the control signals are generated from address generator 16, and the correction and interpolation data read out from the memory at the respective addresses are transmitted to correction and interpolation unit 17 which outputs to digital to analog converter 18 a new set of data corresponding to a new screen size to DAC in response to the control signals.

Address generator 16 and correction and interpolation unit 17 are described in detail hereinafter as shown in FIGS. 13 and 14.

FIG. 13 is a block diagram of address generator 16 for counting the number of clocks FVCO generated from PLL 14 in response to a PLL control signal of controller 11 during a period of a horizontal synchronization signal and for generating a counted number, and controller 11 generates the control signals in accordance with the count number of address generator 16.

Address generator 16 includes a first counter C1 and a first comparator CO1 outputting the NCNT signal in response to the counted number of clocks during the period of the horizontal synchronization signal, comparing the NCNT signal with a previously stored NCNT signal in every period of the horizontal synchronization signal, and generating a first interrupt signal when there exists a difference between the NCNT signal and the previously stored NCNT signal, a first divider D1 receiving a skip number and a first dividing ratio from controller 11 and generating horizontal control signals after dividing by the first dividing ratio a remaining period of the horizontal synchronization signal remained after a number of clocks FVCO corresponding to the skip number from the horizontal synchronization signal are eliminated, a second counter C2 generating horizontal address signals by counting the horizontal control signals generated from first divider D1, a second divider D2 receiving a pass number and a second dividing ratio 2 and generating a vertical control signal after dividing by the second dividing ratio 2 a remaining period of the vertical synchronization signal remained after eliminating a number of horizontal scanning lines corresponding to the pass number from the horizontal synchronization signals disposed within a period of the vertical synchronization signal, a third counter C3 generating a vertical address signal by counting the vertical control signal generated from second divider D2, a fourth counter C4 generating a second counted number by counting the number of the horizontal synchronization signals presented during a vertical synchronization signal period, and a second comparator CO2 receiving the second counted number generated from fourth counter C4 and outputting a second interrupt signal whenever a difference between the second counted number and a previously stored second counted number exists in every period of the vertical synchronization signal only when the first interrupt signal is generated from the first comparator CO1.

Correction and interpolation unit 17 as shown in FIG. 14 includes a RAM 1-1 18A storing and outputting the convergence error correction data in response to the horizontal and vertical address signals, a RAM 2-1 18B storing and outputting the interpolation data in response to the horizontal and vertical address signals, a fifth counter 18C counting, after skipping the number of lines of the horizontal synchronization signals corresponding of the interpolation data, the number of the horizontal synchronization signals existing during the remained period of the vertical control signal in response to the number of lines of the horizontal synchronization signals corresponding to the interpolation data from RAM 2-1 18B and in response to the vertical control signal and the horizontal synchronization signals inputted from address generator 16, a multiplier 18D outputting a multiplied output signal by multiplying third counted numbers of fifth counter 18C with the interpolation data transmitted from controller 11 in response to an enable signal generated in accordance with the number of lines of horizontal synchronization signals corresponding to the interpolation data from RAM 2-1 18B, a code bit discriminator 18G outputting an operation signal in accordance with the correction data and the interpolation data generated from RAM 2-1 18B, and an adder 18E and a subtracter 18F receiving the correction data and the interpolation data from RAM 1-1 18A, RAM 2-1 18B and adding and subtracting the multiplied output data of the multiplier 18D with the operation signal of code bit discriminator in response to the correction data and the interpolation data from RAM 1-1 18A, RAM 2-1 18B.

Correction and interpolation unit 17 may include a multiplexer (MUX) 18H for selectively selecting one of output signals of adder 18E and substracter 18F, and a latch 18I for temperately storing and delaying the one of the output signals outputted from the MUX 18H.

The clock signals FVCO generated from PLL 14 in response to the control signals of controller 11 is inputted to address generator 16. The clock signals FVCO do not vary regardless of the variance of the vertical synchronization signal and horizontal synchronization signal in terms of the period and the number of the vertical synchronization signal and horizontal synchronization signal. When the number of clock signals FVCO are counted during the period of the horizontal synchronization signal is transmitted to microprocessor 11, microprocessor 11 generates the control signals including the skip number, the pass number, a first dividing ratio, a second dividing ratio, and the first comparator clock number. These control signals may be predetermined.

A first divider D1 receives the skip number and the first dividing ratio, subtracts the number of clocks FVCO corresponding to the skip number from the period of the horizontal synchronization signal, divides a remaining period of the subtracted horizontal synchronization signal with the first dividing ratio, and generates horizontal control signals. A second counter C2 generates a horizontal address signals by counting the horizontal control signals.

A second divider D2 receives the pass number and the second dividing ratio, subtracts a number of scanning lines of the horizontal synchronization signals corresponding to the pass number from the period of the vertical synchronization signal, divides a remaining period of the subtracted vertical synchronization signal by the second dividing ratio, and generates vertical control signals. A third counter C3 generates a vertical address signals by counting the vertical control signals.

First counter C1 generates the NCNT signal by counting the number of clock signals FVCO during the period of the horizontal synchronization signal, and first comparator CO1 receives the NCNT signal and generates a difference signal whenever there exists at least one clock difference between the received NCNT signal and the previously stored NCNT signal by comparing the received the NCNT signal with the previously stored NCNT signal. With first comparator CO1, the first interrupt signal is generated in response to the difference caused by the variance of the horizontal synchronization signal.

Fourth counter C4 counts the number of the clock signals corresponding to the number of horizontal synchronization signals generated during the period of the vertical synchronization signal and generates the second counted number to the second comparator C2. The second comparator C2 compares the second counted number and a previously stored second counted number when every vertical synchronization signal is inputted, and generates the second interrupt signal in response to the first interrupt signal when a difference between the second counted number and a previously stored second counted number exists in every period of the vertical synchronization signal

Characteristics and sources of each signal are described as follows.

The horizontal synchronization signal, the vertical synchronization signal, and a picture screen converting mode signal are generated from a TV set having the CRT structure which communicates with the external computer through the serial communication means RS-232C.

The external control command signal is an input signal to select one of the modes in the convergence error correcting apparatus integrated in a one chip. The control signals including the first dividing ratio, the skip number, the second dividing ratio, the pass number, the first comparator clock number, and the MUX control signal are transmitted from microprocessor 11 to address generator 16 and may be inputted by a TV set manufacturer.

A PLL control signal inputted from microprocessor 11 to PLL 14 is a predetermined frequency number, and the interpolation control signal is inputted from microprocessor 11 to correcting and interpolation unit 17 to change and process the interpolation data.

As shown in FIG. 13, address generator 16 generates the NCNT signal, the horizontal address signals, vertical address signals, the horizontal control signals, the vertical control signals, and the first and second interrupt signals in response to the control signals outputted from microprocessor 11 including the skip number, the first dividing ratio, the pass number, the second dividing ratio, the first comparator clock number, the FVCO signal, the vertical synchronization signal, and the horizontal synchronization signal. FIG. 15 shows the characteristics of each control signals generated from address generator 16 and microprocessor 11 in conjunction with the picture screen of the CRT structure.

The output frequency generated from PLL 14, the FVCO signal, is determined by the frequency control signal transmitted from microprocessor 11, and the output frequency of the FVCO signal is inputted to input ports of the first counter C1 and the first divider D1, respectively.

The first divider D1 subtracts the skip number from the number of clocks of the FVCO signal corresponding to the period of the horizontal synchronization signal, generate a remaining period of the horizontal synchronization signal, divides the remaining period of the horizontal synchronization signal with the first dividing ratio D1 to generate the horizontal control signal, and generates the horizontal address signal by counting the horizontal control signal in the second counter C2.

The second divider D2 subtracts the pass number from the number of horizontal synchronization signals during the period of the vertical synchronization signal, generates a remaining period of the vertical synchronization signal, divides the remaining period of the vertical synchronization signal with the second dividing ratio D2, and generates the vertical control signal to generate the vertical address signal by counting the vertical control signal in the third counter C3.

First counter C1, as shown in FIG. 16, generates the NCNT signal by counting the number of the FVCO signal during the every period of the horizontal synchronization signal. The first comparator CO1 receives the NCNT signal and makes a determination of whether there exists at least one clock difference between the received NCNT signal and a previously stored NCNT signal, and generates the first interrupt signal in response to the determination of when the received NCNT signal is different from the previously stored NCNT signal. The first interrupt signal representing that the frequency of the horizontal synchronization signal has been changed is transmitted to microprocessor 11.

After the frequency of the horizontal synchronization signal is changed, the fourth counter C4 counts the number of horizontal synchronization signals inputted during the period of the vertical synchronization signal and outputs the second counted number to the second counter C2. The second interrupt signal representing that the resolution of the picture screen has been changed is transmitted to microprocessor 11 when the second counted number is different from a previously stored number in the second comparator CO2.

The second interrupt signal is generated in response to the discrimination of the resolution change of the picture screen, such as the total number of the horizontal synchronization signals presented during the period of the vertical synchronization signal after the first interrupt signal is generated in response to the frequency change of the horizontal synchronization signal.

Once the first interrupt signal is generated in response to the frequency change of the horizontal synchronization signal, microprocessor 11 computes a second skip number, a third dividing ratio, and a third comparator clock number all used for the changed horizontal synchronization signal in accordance with the amount of the frequency change of the horizontal synchronization signal and transmits to address generator 16 the second skip number, the third dividing ratio, and the third comparator clock number. Once the second interrupt signal is generated in response to the resolution change of the picture screen, microprocessor 11 computes a second pass number and a fourth dividing ratio used for the changed horizontal synchronization signals in accordance with the number of the horizontal synchronization signals and transmits to address generator 16 the second pass number and the fourth dividing ratio.

In FIG. 15, each terminologies of the control signals are explained in conjunction with the screen pattern and the picture screen. The first dividing ratio and the second dividing ratio represent each span between the horizontal addresses and between the vertical addresses all forming the crossing points of the screen pattern as shown in FIG. 15, and the first dividing ratio is shown along the horizontal direction while the second dividing ratio is shown along the vertical direction.

The skip number represents a vertical blank area of the picture screen defined by a first difference between a first signal area formed by the horizontal synchronization signals and a first displayed area displayed on a physical screen of the CRT structure. The pass number represents a horizontal blank area of the picture screen defined by a second difference between a second signal area formed by the vertical synchronization signal and a second displayed area displayed on the physical screen of the CRT structure.

As described above, when the first interrupt signal in response to the frequency change of the horizontal synchronization signal is generated, microprocessor 11 in accordance with the amount of the frequency change of the horizontal synchronization signal computes the second skip number, the third dividing ratio, the fourth comparator clock number which are transmitted to address generator 16. When the second interrupt signal in response to the resolution change caused by the change of the number of the horizontal synchronization signals presented during the period of the vertical synchronization signal is generated, microprocessor 11 generates the second pass number and the fourth dividing ratio which are transmitted to address generator 16.

Whenever any of the frequency change and the resolution change of the horizontal synchronization signals occurs, modified addresses are generates to precisely perform the correcting and interpolating process at the predetermined positions on the changed horizontal and vertical synchronization signals.

Address generator 16 generates the horizontal control signals, the vertical control signals, the horizontal address signals, and the vertical address signals in response to one of the first control signals or the second control signals.

The first Ram 13A stores the correction data corresponding to the convergence errors of the respective crossing points (correcting points) of the screen pattern while the second RAM 13Bstores the interpolation data of the convergence errors corresponding to each area between the two adjacent crossing points. Although each area between the adjacent crossing points does not have the correction data, the area may have the interpolation data for correcting the convergence errors in the areas disposed between the crossing points.

The correction data and the interpolation data stored in the respective first and second RAMs 13A, 13B are outputted in response to the respective addresses generated from address generator 16. Since each of correction data and the interpolation data is independently assigned to respective addresses. The corresponding correction data or the corresponding interpolation data to the respective addresses independently and separately is outputted. The interpolation data includes code bits, the line number, and the interpolation amount.

Third counter18C counts the number of the horizontal synchronization signals disposed within the period of the vertical synchronization signal excluding the number of the horizontal synchronization signals corresponding to the interpolation data. The counted number transmitted to multiplier 18D is multiplied with the interpolation amount of the interpolation data to generate the multiplied amount to adder 18E and subtracter 18F which are operated in accordance with the code bits of the interpolation data. The multiplied amount is added to or subtracted from the correction data.

The areas of the horizontal and vertical blanking periods, which are not displayed on the physical screen, may be controlled in response to the horizontal and vertical control signals set by the user or the manufacturer through MUX 18H set by the user. When each period of the horizontal synchronization signals starts, the correction data corresponding to a first period of a first horizontal synchronization signal is outputted before the first horizontal control signal is generated. When the period of the vertical synchronization signal starts, the predetermined vertical and horizontal control signals inputted by the user are outputted before the vertical control signal is generated. The predetermined vertical and horizontal control signals inputted by the user are outputted in the period defined by the pass number. The correction data and the interpolation data for correcting the convergence errors are outputted after each period of the horizontal synchronization signals corresponding to the skip number.

The number of code bits of the interpolation data stored in the second RAM 18B varies in response to the resolution change of the picture screen. If the resolution is changed because the number of the horizontal synchronization signals is changed, the number of the horizontal synchronization signals disposed between the adjacent correction points and the interpolation amount of the interpolation data which are applied to the interpolation process should be adjusted. Since the interpolation data varies in accordance with each picture screen, the number of the code bits for forming the line number and the interpolation amount of the interpolation data are changed.

If the second interrupt is generated in response to the resolution change, microprocessor 11 generates the recalculated second control signals in accordance with the changed resolution. The number of the code bits and the calculation of the counters, the multiplier, the adder, and the subtracter are changed in response to the recalculated second control signals.

In the magnetic field controlling yoke, each of four pairs of the magnetic field controlling coils being made of double windings or triple windings is disposed around the yoke in opposite sides as shown in FIG. 20. The Terminal pins denote 2V, 2H, 4V, 4H, 6V, 6H, and a ground, respectively.

When the digital dynamic convergence error controlling apparatus operates, respective operations of the magnetic field controlling yoke in response to the correction data and the interpolation data are shown in FIGS. 21 through 26. The magnetic field controlling yoke operates as two pole magnetic field controlling coils, four pole magnetic field controlling coils, or six pole magnetic field controlling coils.

The output signals of the output section 18 of FIG. 12 is transmitted to the terminal pins of FIG. 20 through respective amplifiers not shown. The horizontal two pole magnetic field controlling coils is shown in FIG. 21 while the vertical two pole magnetic field controlling coils is shown in FIG. 22, and the horizontal four pole magnetic field controlling coils is shown in FIG. 23 while the vertical four pole magnetic field controlling coils is shown in FIG. 24. The horizontal six pole magnetic field controlling coils is shown in FIG. 25 while the vertical six pole magnetic field controlling coils is shown in FIG. 26.

FIG. 25 is a diagram showing the digital dynamic convergence error correcting apparatus attached to the magnetic field control yoke device while FIG. 26 is a diagram showing the digital dynamic convergence error correcting apparatus attached to the magnetic field control yoke and the CER structure of the display device.

The digital dynamic convergence error correcting apparatus is made in a separate printed circuit board or integrated into a common printed circuit board in a monolithic structure. FIGS. 27 and 28 shows an example of the digital dynamic convergence error correcting apparatus mounted on the display device in different ways.

As described above, the convergence error is corrected by providing the digital dynamic convergence error correcting apparatus correcting the convergence error occurred in the correcting control points defined by the crossing points of the screen pattern and applying the control current or the control voltage to the magnetic field controlling coils to generate the two pole magnetic fields, the four pole magnetic fields, or the six pole magnetic fields. Therefore, the convergence errors incurred in each correcting control point are corrected throughout the entire portions of the picture screen. High definition quality accomplishing this convergence error correction may be implemented in a HDTV which is currently available in a current market.

Although the preferred embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A digital dynamic convergence error control system, comprising:
a convergence error detecting apparatus recognizing crossing points of a screen pattern displayed on a screen of a display device, detecting each amount of convergence errors corresponding to respective crossing points;
a main control means generating correction data in response to respective convergence errors, generating interpolation data using said correction data of adjacent crossing points; and
a digital dynamic convergence error control apparatus receiving said correction data and said interpolation data from said main control means, storing said correction data and said interpolation data in a memory, converting each of said correction data and said interpolation data into voltage or current in response to respective horizontal synchronization signals extracted from a picture signal, and independently and separately applying said voltage or said current to a magnetic field controlling coil only during a corresponding period of respective horizontal synchronization signals.

2. The system of claim 1, said digital dynamic convergence error control apparatus being integrated in a single chip having a monolithic structure.

3. The system of claim 1, said crossing points of said screen pattern corresponding to respective correction data and being formed by horizontal lines and vertical lines.

4. The system of claim 1, said interpolation data generated in an area disposed between said adjacent crossing points of said screen pattern, said area corresponding to horizontal synchronization signals of said picture signal disposed between said adjacent crossing points of said screen pattern, said crossing points of said screen pattern being formed by horizontal lines and vertical lines.

5. The system of claim 1, said digital dynamic convergence error control apparatus comprising:
a controller receiving said correction data, said interpolation data, and control command signals from said main control means, generating address corresponding to each of said correction data and said interpolation data, storing said correction data and said interpolation data in respective addresses of said memory, controlling an address bus and a data bus to read said correction data and said interpolation data from respective addresses of said memory;
a reference clock generator generating clock signals in response to a clock control signal inputted from said controller;
an address generator generating an interrupt signal and setup signals for calculating said interpolation data corresponding to an area between adjacent crossing points in response to horizontal and vertical synchronization signals extracted from said picture signal, control signals generated from said controller, and said clock signals generated from said reference clock generator;
an internal memory storing said correction data and said interpolation data inputted into said controller; and
an output section converting said correction data and said interpolation data into said voltage and said current in response to output control signals generated from said controller and a conversion control signal generated from said address generator, and applying said voltage and said current to said magnetic field controlling coils for generating more than two pole magnetic fields.

6. The system of claim 5, said control signals of said controller including a skip number, a first dividing ratio, a pass number, and a second dividing ratio, a first comparator clock number, and a main clock signal transmitted to said reference clock generator.

7. The system of claim 5, said setup signals of said controller including an NCNT signal, a horizontal address, a vertical address, a horizontal control signal, and a vertical control signal.

8. The system of claim 5, further comprising a nonvolatile external memory disposed outside said digital dynamic convergence error correction apparatus, coupled to said controller, storing said correction data and said interpolation data, said correction data and said interpolation data stored in said nonvolatile memory transmitted to said internal memory in response to a request signal of said controller.

9. The system of claim 5, said digital dynamic convergence error control apparatus comprising said controller generating said control signals by counting the number of said clock signals generated from said reference clock generator during a period of a horizontal synchronization signal of said picture signal in response to said clock control signal of said controller, said address generator of digital dynamic convergence error control apparatus comprising:
a first counter and a first comparator generating an NCNT signal as one of setup signals in response to said number of said clock signals counted during said period of said horizontal synchronization signal, generating a first interrupt signal whenever there exists a difference between the NCNT and a reference;
a first divider receiving a skip number and a first dividing ratio, generating a horizontal control signal as one of said setup signals after dividing by said first dividing ratio a remaining portion of said horizontal synchronization signal remained after skipping said horizontal synchronization signal by a number of clock signals corresponding to the skip number;
a second counter generating horizontal address signal by counting the horizontal control signal generated from said first divider;
a second divider receiving a pass number and a second dividing ratio and generating a vertical control signal after dividing by said second dividing ratio a remaining portion of said vertical synchronization signal remained after passing a number of horizontal synchronization signals corresponding to the pass number during said vertical synchronization signal;
a third counter generating a vertical address signal by counting the vertical control signal generated from said second divider;
a fourth counter generating a count value by counting the number of clocks of the horizontal synchronization signal during a vertical synchronization signal period; and
a second comparator receiving said count value generated from fourth counter, outputting a second interrupt signal whenever a difference between the count value and a second reference by counting the number of clocks in every vertical synchronization signal only when said first comparator generates said first interrupt signal.

10. The system of claim 5, said digital dynamic convergence error control apparatus comprising:
a plurality of digital to analog converters converting into each analog signal said correction data and said interpolation data corresponding to respective magnetic field correcting coils generating more than two pole magnetic fields corresponding to respective vertical and horizontal axes of said magnetic field correcting coils; and
a plurality of correction and interpolation units coupled to respective said digital to analog converters, receiving said correction data and said interpolation data from said internal memory, transmitting said correction data and said interpolation data to corresponding digital to analog converter so as to control respective magnetic field controlling coils designated by each coil address generated from said address generator with corresponding correction data and corresponding interpolation data.

11. The system of claim 5, said digital dynamic convergence error control apparatus comprising:
a first memory storing and outputting said correction data in response to said horizontal and vertical address;
a second memory storing and outputting the interpolation data in response to said horizontal and vertical address;
a counter for receiving vertical and horizontal synchronization signals from said address generator and each line number of said interpolation data from said second memory, counting each line number of said horizontal synchronization signals existing during the vertical control signal by skipping said line number of said horizontal synchronization signals corresponding to said interpolation data;
a multiplier for outputting a multiplied output signal by multiplying a counted signal of said counter with said interpolation data transmitted from said second controller in response to an enable signal generated in accordance with said line number of said interpolation data from said second memory;
a code bit discriminator for receiving and recognizing said interpolation data from said second memory, outputting an operation signal depending on the status of said interpolation data; and
an adder and a subtracter for receiving said correction data from said first memory and said interpolation data from said second memory, adding and subtracting said multiplied output signal of said multiplier in response to said operation signal from said code bit discriminator.

12. A digital dynamic convergence error control apparatus, comprising:
a nonvolatile external memory storing correction data and interpolation data for correcting convergence errors corresponding to crossing points of a screen pattern;
a controller receiving said correction data and said interpolation data from said nonvolatile external memory through a data bus and an address bus, generating control signals for proceeding a convergence error correcting and interpolating process for each portion of said screen pattern;
a reference clock generator generating clock signals in response to a clock control signal inputted from said controller;
an address generator generating an interrupt signal and setup signals for calculating said interpolation data corresponding to an area between adjacent crossing points in response to horizontal and vertical synchronization signals extracted from said picture signal, control signals generated from said controller, and said clock signals generated from said reference clock generator;
an internal memory storing said correction data and said interpolation data inputted into said controller; and
an output section converting said correction data and said interpolation data into said voltage and said current in response to output control signals generated from said controller and a conversion control signal generated from said address generator, and applying said voltage and said current to said magnetic field controlling coils for generating more than two pole magnetic fields.

13. The apparatus of claim 12, said digital dynamic convergence error control apparatus being made of a single semiconductor chip in a monolithic structure excluding said nonvolatile external memory.

14. The apparatus of claim 12, said crossing points of said screen pattern corresponding to respective correction data and being formed by horizontal lines and vertical lines.

15. The apparatus of claim 12, said interpolation data generated in an area disposed between said adjacent crossing points of said screen pattern, said area corresponding to horizontal synchronization signals of said picture signal disposed between said adjacent crossing points of said screen pattern, said crossing points of said screen pattern being formed by horizontal lines and vertical lines.

16. The apparatus of claim 12, said control signals of said controller including a skip number, a first dividing ratio, a pass number, and a second dividing ratio, a first comparator clock number, and a main clock signal transmitted to said reference clock generator.

17. The apparatus of claim 12, said setup signals of said address generator including an NCNT signal, a horizontal address, a vertical address, a horizontal control signal, and a vertical control signal.

18. The apparatus of claim 12, said controller generating said control signals by counting the number of said clock signals generated from said reference clock generator during a period of a horizontal synchronization signal of said picture signal in response to said clock control signal of said controller, said address generator of said digital dynamic convergence error control apparatus comprising:
a first counter and a first comparator generating an NCNT signal as one of setup signals in response to said number of said clock signals counted during said period of said horizontal synchronization signal, generating a first interrupt signal whenever there exists a difference between the NCNT and a reference;
a first divider receiving a skip number and a first dividing ratio, generating a horizontal control signal as one of said setup signals after dividing by said first dividing ratio a remaining portion of said horizontal synchronization signal remained after skipping said horizontal synchronization signal by a number of clock signals corresponding to the skip number;
a second counter generating horizontal address signal by counting the horizontal control signal generated from said first divider;
a second divider receiving a pass number and a second dividing ratio and generating a vertical control signal after dividing by said second dividing ratio a remaining portion of said vertical synchronization signal remained after passing a number of horizontal synchronization signals corresponding to the pass number during said vertical synchronization signal;
a third counter generating a vertical address signal by counting the vertical control signal generated from said second divider;
a fourth counter generating a count value by counting the number of clocks of the horizontal synchronization signal during a vertical synchronization signal period; and
a second comparator receiving said count value generated from fourth counter, outputting a second interrupt signal whenever a difference between the count value and a second reference by counting the number of clocks in every vertical synchronization signal only when said first comparator generates said first interrupt signal.

19. The apparatus of claim 12, said output section comprising:
a plurality of digital to analog converters converting into each analog signal said correction data and said interpolation data corresponding to respective magnetic field correcting coils generating more than two pole magnetic fields corresponding to respective vertical and horizontal axes of said magnetic field correcting coils; and
a plurality of correction and interpolation sections coupled to respective said digital to analog converters, receiving said correction data and said interpolation data from said internal memory, transmitting said correction data and said interpolation data to corresponding digital to analog converter so as to control respective magnetic field controlling coils designated by each coil address generated from said address generator with corresponding correction data and said interpolation data.

20. The apparatus of claim 12, further comprising a correction and interpolation section including:
a first memory storing and outputting the correction data in response to said horizontal and vertical addresses;
a second memory storing and outputting the interpolation data in response to said horizontal and vertical address;
a counter for receiving vertical and horizontal synchronization signals from said address generator and each line number of said interpolation data from said second memory, counting each line number of said horizontal synchronization signals existing during the vertical control signal by skipping said line number of said horizontal synchronization signals corresponding to said interpolation data;
a multiplier for outputting a multiplied output signal by multiplying a counted signal of said counter with said interpolation data transmitted from said second controller in response to an enable signal generated in accordance with said line number of said interpolation data from said second memory;
a code bit discriminator for receiving and recognizing said interpolation data from said second memory, outputting an operation signal depending on the status of said interpolation data; and
an adder and a subtracter for receiving said correction data from said first memory and said interpolation data from said second memory, adding and subtracting said multiplied output signal of said multiplier in response to said operation signal from said code bit discriminator.

21. A deflection yoke having a digital dynamic convergence error correcting apparatus, comprising:
a coil separator having a neck portion coupled to a CRT;
a horizontal deflection coil and a vertical deflection coil provided on said coil separator;
a plurality of magnetic field controlling coils for generating more than two pole magnetic fields;
a nonvolatile external memory storing correction data and interpolation data for correcting convergence errors corresponding to crossing points of a screen pattern;
a controller receiving said correction data and said interpolation data from said nonvolatile external memory through a data bus and an address bus, generating control signals for proceeding a convergence error correcting and interpolating process for each portion of said screen pattern;
a reference clock generator generating clock signals in response to a clock control signal inputted from said controller;
an address generator generating an interrupt signal and setup signals for calculating said interpolation data corresponding to an area between adjacent crossing points in response to horizontal and vertical synchronization signals extracted from said picture signal, control signals generated from said controller, and said clock signals generated from said reference clock generator;
an internal memory storing said correction data and said interpolation data inputted into said controller; and
an output section converting said correction data and said interpolation data into said voltage and said current in response to output control signals generated from said controller and a conversion
control signal generated from said address generator, and applying said voltage and said current to said magnetic field controlling coils for generating more than two pole magnetic fields.

22. The deflection yoke of claim 21, wherein said controller, said reference clock generator, said address generator, said internal memory, and said output section all being integrated in a single semiconductor chip having a monolithic structure.

23. The deflection yoke of claim 21, said crossing points of said screen pattern corresponding to respective correction data and being formed by horizontal lines and vertical lines.

24. The deflection yoke of claim 21, said interpolation data generated in an area disposed between said adjacent crossing points of said screen pattern, said area corresponding to horizontal synchronization signals of said picture signal disposed between said adjacent crossing points of said screen pattern, said crossing points of said screen pattern being formed by horizontal lines and vertical lines.

25. The deflection yoke of claim 21, said control signals of said controller including a skip number, a first dividing ratio, a pass number, and a second dividing ratio, a first comparator clock number, and a main clock signal transmitted to said reference clock generator.

26. The deflection yoke of claim 21, said setup signals of said address generator including an NCNT signal, a horizontal address, a vertical address, a horizontal control signal, and a vertical control signal.

27. The deflection yoke of claim 21, said controller generating said control signals by counting the number of said clock signals generated from said reference clock generator during a period of a horizontal synchronization signal of said picture signal in response to said clock control signal of said controller, said address generator of said digital dynamic convergence error control apparatus comprising:
a first counter and a first comparator generating an NCNT signal as one of setup signals in response to said number of said clock signals counted during said period of said horizontal synchronization signal, generating a first interrupt signal whenever there exists a difference between the NCNT and a reference;
a first divider receiving a skip number and a first dividing ratio, generating a horizontal control signal as one of said setup signals after dividing by said first dividing ratio a remaining portion of said horizontal synchronization signal remained after skipping said horizontal synchronization signal by a number of clock signals corresponding to the skip number;
a second counter generating horizontal address signal by counting the horizontal control signal generated from said first divider;
a second divider receiving a pass number and a second dividing ratio and generating a vertical control signal after dividing by said second dividing ratio a remaining portion of said vertical synchronization signal remained after passing a number of horizontal synchronization signals corresponding to the pass number during said vertical synchronization signal;
a third counter generating a vertical address signal by counting the vertical control signal generated from said second divider;
a fourth counter generating a count value by counting the number of clocks of the horizontal synchronization signal during a vertical synchronization signal period; and
a second comparator receiving said count value generated from fourth counter, outputting a second interrupt signal whenever a difference between the count value and a second reference by counting the number of clocks in every vertical synchronization signal only when said first comparator generates said first interrupt signal.

28. The deflection yoke of claim 21, said output section comprising:
a plurality of digital to analog converters converting into each analog signal said correction data and said interpolation data corresponding to respective magnetic field correcting coils generating more than two pole magnetic fields corresponding to respective vertical and horizontal axes of said magnetic field correcting coils; and
a plurality of correction and interpolation sections coupled to respective said digital to analog converters, receiving said correction data and said interpolation data from said internal memory, transmitting said correction data and said interpolation data to corresponding digital to analog converter so as to control respective magnetic field controlling coils designated by each coil address generated from said address generator with corresponding correction data and said interpolation data.

29. The deflection yoke of claim 21, further comprising a correction and interpolation section including:
a first memory storing and outputting the correction data in response to said horizontal and vertical address;
a second memory storing and outputting the interpolation data in response to said horizontal and vertical address;
a counter for receiving vertical and horizontal synchronization signals from said address generator and each line number of said interpolation data from said second memory, counting each line number of said horizontal synchronization signals existing during the vertical control signal by skipping said line number of said horizontal synchronization signals corresponding to said interpolation data;
a multiplier for outputting a multiplied output signal by multiplying a counted signal of said counter with said interpolation data transmitted from said second controller in response to an enable signal generated in accordance with said line number of said interpolation data from said second memory;
a code bit discriminator for receiving and recognizing said interpolation data from said second memory, outputting an operation signal depending on the status of said interpolation data; and
an adder and a subtracter for receiving said correction data from said first memory and said interpolation data from said second memory, adding and subtracting said multiplied output signal of said multiplier in response to said operation signal from said code bit discriminator.

30. A display device having a digital dynamic convergence error correcting apparatus, comprising:
a deflection yoke deflecting electron beams emitted from an electron gun of a CRT;
a plurality of magnetic field controlling coils for generating more than two pole magnetic fields;
a nonvolatile external memory storing correction data and interpolation data for correcting convergence errors corresponding to crossing points of a screen pattern;
a controller receiving said correction data and said interpolation data from said nonvolatile external memory through a data bus and an address bus, generating control signals for proceeding a convergence error correcting and interpolating process for each portion of said screen pattern;
a reference clock generator generating clock signals in response to a clock control signal inputted from said controller;
an address generator generating an interrupt signal and setup signals for calculating said interpolation data corresponding to an area between adjacent crossing points in response to horizontal and vertical synchronization signals extracted from said picture signal, control signals generated from said controller, and said clock signals generated from said reference clock generator;
an internal memory storing said correction data and said interpolation data inputted into said controller; and
an output section converting said correction data and said interpolation data into said voltage and said current in response to output control signals generated from said controller and a conversion
control signal generated from said address generator, and applying said voltage and said current to said magnetic field controlling coils for generating more than two pole magnetic fields.

31. The display device of claim 30, wherein said controller, said reference clock generator, said address generator, said internal memory, and said output section all being integrated in a single semiconductor chip having a monolithic structure.

32. The display device of claim 30, said crossing points of said screen pattern corresponding to respective correction data and being formed by horizontal lines and vertical lines.

33. The display device of claim 30, said interpolation data generated in an area disposed between said adjacent crossing points of said screen pattern, said area corresponding to horizontal synchronization signals of said picture signal disposed between said adjacent crossing points of said screen pattern, said crossing points of said screen pattern being formed by horizontal lines and vertical lines. said convergence error correction data being corresponding to respective crossing points of said screen pattern being formed by horizontal lines and vertical lines.

34. The display device of claim 30, said control signals of said controller including a skip number, a first dividing ratio, a pass number, and a second dividing ratio, a first comparator clock number, and a main clock signal transmitted to said reference clock generator.

35. The display device of claim 30, said setup signals of said address generator including an NCNT signal, a horizontal address, a vertical address, a horizontal control signal, and a vertical control signal.

36. The display device of claim 30, said controller generating said control signals by counting the number of said clock signals generated from said reference clock generator during a period of a horizontal synchronization signal of said picture signal in response to said clock control signal of said controller, said address generator of digital dynamic convergence error control apparatus comprising:
a first counter and a first comparator generating an NCNT signal as one of setup signals in response to said number of said clock signals counted during said period of said horizontal synchronization signal, generating a first interrupt signal whenever there exists a difference between the NCNT and a reference;
a first divider receiving a skip number and a first dividing ratio, generating a horizontal control signal as one of said setup signals after dividing by said first dividing ratio a remaining portion of said horizontal synchronization signal remained after skipping said horizontal synchronization signal by a number of clock signals corresponding to the skip number;
a second counter generating horizontal address signal by counting the horizontal control signal generated from said first divider;
a second divider receiving a pass number and a second dividing ratio and generating a vertical control signal after dividing by said second dividing ratio a remaining portion of said vertical synchronization signal remained after passing a number of horizontal synchronization signals corresponding to the pass number during said vertical synchronization signal;
a third counter generating a vertical address signal by counting the vertical control signal generated from said second divider;
a fourth counter generating a count value by counting the number of clocks of the horizontal synchronization signal during a vertical synchronization signal period; and
a second comparator receiving said count value generated from fourth counter, outputting a second interrupt signal whenever a difference between the count value and a second reference by counting the number of clocks in every vertical synchronization signal only when said first comparator generates said first interrupt signal.

37. The display device of claim 30, said output section comprising:
a plurality of digital to analog converters converting into each analog signal said correction data and said interpolation data corresponding to respective magnetic field correcting coils generating more than two pole magnetic fields corresponding to respective vertical and horizontal axes of said magnetic field correcting coils; and
a plurality of correction and interpolation sections coupled to respective said digital to analog converters, receiving said correction data and said interpolation data from said internal memory, transmitting said correction data and said interpolation data to corresponding digital to analog converter so as to control respective magnetic field controlling coils designated by each coil address generated from said address generator with corresponding correction data and said interpolation data.

38. The display device of claim 30, further comprising a correction and interpolation section including:
a first memory storing and outputting the correction data in response to said horizontal and vertical address;
a second memory storing and outputting the interpolation data in response to said horizontal and vertical address;
a counter for receiving vertical and horizontal synchronization signals from said address generator and each line number of said interpolation data from said second memory, counting each line number of said horizontal synchronization signals existing during the vertical control signal by skipping said line number of said horizontal synchronization signals corresponding to said interpolation data;
a multiplier for outputting a multiplied output signal by multiplying a counted signal of said counter with said interpolation data transmitted from said second controller in response to an enable signal generated in accordance with said line number of said interpolation data from said second memory;
a code bit discriminator for receiving and recognizing said interpolation data from said second memory, outputting an operation signal depending on the status of said interpolation data; and
an adder and a subtracter for receiving said correction data from said first memory and said interpolation data from said second memory, adding and subtracting said multiplied output signal of said multiplier in response to said operation signal from said code bit discriminator.

39. An apparatus for generating a convergence reference signal for correcting convergence errors in a picture displayed on a screen of a CRT by controlling a plurality of magnetic field controlling coils for generating more than two pole magnetic fields corresponding to one of horizontal and vertical axes, comprising:
a controller generating control signals including a skip number, a pass number, a first dividing ratio, a second dividing ratio, and clocks;
a first counter and a first comparator generating a counted number by counting the number of said clocks during a period of a horizontal synchronization signal, generating a first interrupt signal whenever there exists a difference between said counted number and a reference number;
a first divider receiving said skip number and said first dividing ratio, subtracting said the number of said clocks corresponding to the skip number from the period of the horizontal synchronization signal, dividing a remaining period of the subtracted horizontal synchronization signal by the first dividing ratio, and generating a horizontal control signal.
a second counter generating a horizontal address signal by counting said horizontal control signal generated from said first divider;
a second divider receiving said second dividing ratio and said pass number representing that a number of horizontal synchronization signals are eliminated, subtracting the number of horizontal synchronization signals corresponding to the pass number from a total number of horizontal synchronization signals during a period of said vertical synchronization signal, dividing a remaining number of said horizontal synchronization signals of said vertical synchronization signal by said second dividing ratio, and generating a vertical control signal;
a third counter generating a vertical address signal by counting said vertical control signal;
a fourth counter generating a count value by counting the number of clocks of the horizontal synchronization signal during a vertical synchronization signal period; and
a second comparator receiving the count value generated from said fourth counter and outputting a second interrupt signal whenever a difference between the count value and a reference value in every vertical synchronization signal only when said first comparator generates said first interrupt signal.

40. The apparatus of claim 39, wherein said convergence reference signal for correcting convergence errors in a picture displayed on a screen of a CRT is generated in response to said control signals by reading correction data and interpolation data stored in a memory coupled to said apparatus in accordance with the number of said clocks counted during said period of said horizontal synchronization signal.

41. A correcting and interpolating apparatus in a digital dynamic convergence error correcting apparatus, comprising:
an address generator for generating a convergence error correction reference point address for correcting convergence errors of a picture displayed in a screen of a CRT;
an interpolating apparatus for performing a convergence error correcting and interpolating process by controlling respective magnetic field controlling coils corresponding to vertical and horizontal axes;
a first memory storing and outputting the correction data in response to said horizontal and vertical address;
a second memory storing and outputting the interpolation data in response to said horizontal and vertical address;
a counter for receiving vertical and horizontal synchronization signals from said address generator and each line number of said interpolation data from said second memory, counting each line number of said horizontal synchronization signals existing during the vertical control signal by skipping said line number of said horizontal synchronization signals corresponding to said interpolation data;
a multiplier for outputting a multiplied output signal by multiplying a counted signal of said counter with said interpolation data transmitted from said second controller in response to an enable signal generated in accordance with said line number of said interpolation data from said second memory;
a code bit discriminator for receiving and recognizing said interpolation data from said second memory, outputting an operation signal depending on the status of said interpolation data; and
an adder and a subtracter for receiving said correction data from said first memory and said interpolation data from said second memory, adding and subtracting said multiplied output signal of said multiplier in response to said operation signal from said code bit discriminator.

42. The interpolating apparatus of claim 41, wherein an area for correcting said convergence error in accordance with said correction data outputted from said first memory corresponds to respective correction points of said screen indicated by respective convergence error correction reference point addresses.

43. The display device of claim 41, wherein an area for being interpolated in accordance with said interpolation data outputted from said second memory corresponds to said horizontal synchronization signals disposed between correction points indicated by respective adjacent convergence error correction reference point addresses.

44. A convergence error correcting apparatus in a display device, comprising a memory storing a plurality of independent and separate convergence error correction data signals corresponding to respective correction points within a period of a specific horizontal synchronization signal.

45. A convergence error correcting apparatus in a display device, comprising a memory storing a plurality of independent and separate convergence error correction data signals corresponding to respective correction points within each period of specific horizontal synchronization signals, said memory storing a plurality of interpolation data signals corresponding to horizontal synchronization signals disposed between adjacent correction points.

46. A convergence error correcting apparatus in a display device, comprising a controller independently and separately generating a plurality of independent and separate convergence error correction data signals corresponding to respective correction points of a screen pattern and independently and separately applying each of convergence error correction data signals to magnetic field controlling coils when each correction point corresponding to respective convergence error correction data signals is scanned in a screen.

47. A convergence error correcting apparatus in a display device, comprising:
a memory storing a plurality of independent and separate convergence error correction data signals corresponding to respective correction points within each period of specific horizontal synchronization signals, said memory storing a plurality of interpolation data signals corresponding to horizontal synchronization signals disposed between adjacent correction points; and
a controller coupled to said memory, independently reading each of said convergence error correction data signals from said memory when corresponding correction point is scanned in a screen.

48. A convergence error correcting apparatus in a display device, comprising a controller generating a first separate and independent convergence error correction data corresponding to respective first pixels in a first screen having a first screen size in response to the number of first horizontal synchronization signals in a first vertical synchronization signal, said controller generating a first separate and independent interpolation data signals corresponding to a first area disposed between adjacent first pixels, said controller generating a second separate and independent convergence correction data corresponding to respective second pixels in a second screen having a second screen size in response to the number of second horizontal synchronization signals in a second vertical synchronization signal, said controller generating a second separate and independent interpolation data signals corresponding to a second area disposed between adjacent second pixels.

49. A process in a convergence error correcting apparatus, comprising the steps of:
storing a plurality of independent and separate convergence error correction data signals corresponding to respective correction points within each period of specific horizontal synchronization signals;
storing a plurality of interpolation data signals corresponding to horizontal synchronization signals disposed between adjacent correction points; and
independently and separately generating a plurality of independent and separate convergence error correction data signals corresponding to respective correction points of a screen pattern and independently and separately applying each of convergence error correction data signals to magnetic field controlling coils when each correction point corresponding to respective convergence error correction data signals is scanned in a screen.

50. A process in a convergence error correcting apparatus, comprising the steps of:
storing a first separate and independent convergence error correction data corresponding to respective first pixels in a first screen having a first screen size in response to the number of first horizontal synchronization signals in a first vertical synchronization signal;
storing a first separate and independent interpolation data signals corresponding to a first area disposed between adjacent first pixels;
converting said first convergence error correction data signals and said first interpolation data signals into a second separate and independent convergence correction data and a second interpolation data signals corresponding to respective second pixels in a second screen signal having a second screen size in response to the number of second horizontal synchronization signals in a second vertical synchronization signal.
